(19) United States
(12) Patent Application Publication
(10) Pub. No.: US 2026/0221047 A1
(43) Pub. Date: Jul. 30, 2026

(54) INTEGRATED LEARNING METHOD AND SYSTEM

(71) Applicant: Takeshi FUJITA, Ibaraki (JP)

(72) Inventor: Takeshi FUJITA, Ibaraki (JP)

(21) Appl. No.: 19/576,505

(22) Filed: Mar. 24, 2026

Related U.S. Application Data
(63) Continuation of application No. PCT/JP2024/022723, filed on Jun. 24, 2024.

(30) Foreign Application Priority Data
Oct. 11, 2023 (JP) 2023-175611

(51) Int. Cl. G09B 5/06; G09B 7/04

(52) U.S. Cl. CPC G09B 5/065; G09B 7/04

(57) ABSTRACT

The integrated learning method and integrated learning system of the present invention are intended to provide learning software that anyone can easily use and that enables learning by utilizing the latest technologies. The integrated learning method and integrated learning system are characterized by learning through a first step of understanding, a second step of memorization, and a third step of monitoring the learner’s individual study activities to collect and store big data. The configuration of the integrated learning system includes an e-book viewer, a search engine, a network, a generative AI (including generative AI available on the web), a web browser display unit, and a learning card display unit. By using the generative AI to perform investigation, questioning, question creation, and review, efficient learning can be achieved.

### TECHNICAL FIELD

The present invention relates to an integrated learning program for effective learning using electronic learning cards.

### BACKGROUND ART

An inventive step of digital technology is modified from a book based on paper to an electronic file, and results in a large change in the learning method due to the development of the Internet. From such a situation, learning using the generation AI is also performed recently.

Patent Document 1 aims to improve convenience in document information management and document retrieval, enhance operability of retrieval by a keyword, and further improve workability when performing retrieval from a hypertext, by executing a search using a word that is not linked through a click operation as a keyword, and enabling a jump from the clicked word, functioning as a button of the hypertext, to the page to be retrieved.

Patent Document 2 discloses an information processing apparatus that automatically presents dictionary data according to the user's language proficiency or level of specialized knowledge. This apparatus includes a storage unit that stores resource priority information indicating the priority order of multiple sets of dictionary data. From the multiple sets of dictionary data, the apparatus selects the dictionary data with the highest priority, uses the selected dictionary data to search for information on the character string specified via the input unit, and displays the other dictionary data, which was not selected, on the display unit as the next candidate in accordance with the priority order.

When a signal indicating the selection of dictionary data from the next candidate is received from the input unit, the information of the string is searched using the selected dictionary data from the next candidate. For each of the multiple dictionary data, the system manages the number of times a signal indicating the confirmation of search results using the dictionary data received from the input unit. A priority calculation unit is provided, which updates the resource priority information based on the number of times.

Patent Document 3 provides a program, analysis method, computer, and machine learning program for quantitatively analyzing the required accuracy of deep learning models combined with an AI (Artificial Intelligence) system. The analysis program causes the computer to perform processing that creates accuracy criteria information for multiple deep learning models in an AI system, using discrete threshold evaluation, within a space where accuracy evaluation information is projected in multiple dimensions.

### Prior Art Documents

### Patent Documents

Patent Document 1: Japanese Laid-open Patent Publication No. 2007-213609 A

Patent Document 2: Japanese Laid-open Patent Publication No. 2010-33139 A

Patent Document 3: Japanese Laid-open Patent Publication No. 2023-113047 A

### SUMMARY OF THE INVENTION

### Problem to be Solved by the Invention

Learning software becomes a more effective method when it is customized to the needs and skills of the learners. Each learner has a unique learning style. More advanced adaptability is required to adjust content and activities according to the learner's progress. Additionally, appropriate and objective evaluation and feedback regarding the learner's learning methods are important for enhancing learning effectiveness. A challenge lies in providing detailed feedback by integrating objective evaluations with the learner's self-assessments regarding their learning methods. Detailed feedback on learning method can be provided by integrating objective evaluation and the learner's own evaluation.

Recently, generative AI has been gaining significant attention, marking a major turning point in learning methods. To effectively study in this evolving environment, learners need digital literacy, including knowledge of how to properly use digital tools and assess the reliability of information. However, acquiring digital literacy and understanding information reliability can be challenging as part of the preparation for learning. Therefore, there is a growing demand for learning software that is easy to use.

The purpose of the present invention is to provide learning software that anyone can easily use and that enables learning by utilizing the latest technology.

### Problems to be Solved by the Invention

1 The integrated learning method of the present invention comprises: a first step in which a learner selects a learning subject and a learning item belonging to the learning subject, and a computer, based on answers to the learning item obtained using at least the Internet or a generative AI, summarizes content understood by the learner into a learning card including a question section, an answer section, and a remarks section, and stores the learning card; a second step in which the computer displays the question section stored in the learning card, the learner generates an answer to the question section by estimation, vocalization, or handwriting, and reviews the learning card while confirming whether the generated answer matches the answer stored in the learning card; and a third step in which the computer monitors study activities of the learner and collects and stores big data representing a learning history of the learner,

2 In the integrated learning method, in the first step: the learner selects the learning subject and the learning item belonging to the learning subject, and the computer generates a pre‑study preparation table through a pre‑study preparation procedure; the pre‑study preparation procedure includes generating a learning method based on an overview of the learning item, key points, advice and cautions regarding the learning method, and a standard learning time, from answers obtained using the Internet or the generative AI with respect to the specified learning item; the pre‑study preparation table includes a learning‑method field, and the computer stores, in the learning‑method field, the learning item, the learning method, and a standard acquisition time serving as a guideline for acquisition by the learning method.

3 In the integrated learning method, the pre‑study preparation procedure further includes transmitting, in addition to the learning item, preferences and interests of the learner to a web page on the Internet accessible by the generative AI.

4 In the integrated learning method, the computer searches for practical examples and social phenomena related to the learning item, displays, at higher ranks in search results, web pages and documents related to the preferences and interests input by the learner, and enables the learner to open a selected detailed page.

5 An integrated learning system comprising: an e-book viewer configured to select a textbook, reference book, or learning book to be studied and to display content; a content storage unit configured to store electronic documents; a directory storage unit configured to store directory information of the content; a learning subject storage unit configured to register and store learning subjects to be studied; a target examination name storage unit configured to register and store a name of an examination to be taken; a selected character string storage unit configured to select and store character strings in a document, the character strings including learning item names, words, technical terms, case numbers, and past examination question numbers; a selected image character string conversion unit configured to select character images within an image in the document, convert the selected character images into editable text data, and store the converted text data as selected character strings in the selected character string storage unit; a search engine configured to perform an Internet search using, as one set, the registered learning subject, the target examination name, and at least one of the selected character strings or the selected image character strings; a network connected to the search engine; a generative AI accessible via the network and configured to perform the search; a search result display unit configured to display search results in a web browser; a search result storage unit configured to store the learning subject, the selected character strings, and the search results; a URL storage unit configured to store URLs accessed by the web browser; a learning card display unit configured to display a learning card including a question section, an answer section, and a remarks section; a learning display unit configured to display a learning screen including a learning-subject section and having a search function and a review function; a learning result storage unit configured to store results learned in the learning screen as learning cards; a date acquisition and storage unit configured to acquire and store a date on which learning is performed in the learning screen; and a prompt automatic creation unit configured to automatically create prompts, wherein a first step comprises understanding content of a learning item selected by a learner using the integrated learning system, a second step comprises reviewing the understood content, and a third step comprises collecting and storing big data representing a learning history of the learner, whereby the integrated learning system performs integrated learning based on the first, second, and third steps.

6 In the integrated learning system, the e-book viewer is configured, when a file is selected and opened from a list of e-book files, to automatically acquire a learning subject described in the e-book file and store the acquired learning subject in the learning subject storage unit.

7 In the integrated learning system, the e-book viewer is configured, upon opening an e-book file, to obtain a publisher name stored in the e-book file together with a learning subject and to store the publisher name in the publisher name storage unit.

8 In the integrated learning system, the e-book viewer is configured to: acquire, when an e-book file is opened or when pages are turned, a directory in a PC in which the electronic content is stored and a page number of the e-book text from a displayed text page, and update and store the acquired directory and page number in the directory storage unit; and store, when a character string on the text page is stored in the question section of a learning card and text from a website opened by a network search is stored in the answer section to create the learning card, the directory and page number stored in the directory storage unit in the learning card.

9 In the integrated learning system, the e-book viewer is configured to, when a character string is selected from a displayed e-book text page and an Internet search is performed to open a website, acquire a URL of the opened website and store the acquired URL in the URL storage unit; and store, when a character string from the text page is stored in a question section of a learning card and a character string from the website is stored in an answer section to create the learning card, the URL stored in the URL storage unit in the learning card.

10 In the integrated learning system, the e-book viewer is configured, when learning is performed using text, figures, images, or explanatory videos displayed in the content display unit or a browser, to create question items representing unclear points in text or voice format, transmit the question items together with the learning subject to the generative AI, and store question text and response text returned from the generative AI in the learning card.

11 In the integrated learning system, the prompt automatic creation unit is configured to register, in advance, individual information of a learner indicating personal attributes including age and proficiency level; select an appropriate template sentence from among a plurality of example sentences based on the registered information, apply the registered information to the selected template sentence, and automatically create a prompt under constraint conditions; transmit, when the learner inputs and displays a question sentence on an e-book viewer screen and clicks a “question” button, the prompt together with the question sentence to the generative AI

12 In the integrated learning system, the prompt automatic creation unit is configured to: allow the learner to designate a personal tutor character defined in the system as an answering entity; store, for each of a plurality of personal tutor characters, basic information including expertise, personality, and an expected answering standpoint, and corresponding character images; allow the learner to designate a personal tutor character by clicking a corresponding character image; and automatically select an appropriate template sentence and generate a prompt according to the designated personal tutor character, and transmit the generated prompt together with the question sentence to the generative AI when the learner clicks the “question” button.

13 In the integrated learning system, a problem statement related to the selected character string is generated by the generative AI; the learner creates an answer to the problem statement;

the generative AI determines whether the answer is correct; the learner repeatedly creates answers until the answer is determined to be correct; after the answer is determined to be correct, the generative AI evaluates the learner’s level of understanding and weaknesses based on exchanges of correct and incorrect answers with the learner, and generates and presents a next problem; and the problems, answers, and determinations generated by the generative AI are stored in the learning card;

14 In the integrated learning system, part or all of a response returned from the generative AI is transmitted, together with a prompt requesting determination of truthfulness or factual accuracy, to a generative AI of a different system or company to determine reliability and confidence level and to identify problematic portions, and determination results including the confidence level and problematic portions are displayed in a browser; the learner examines the response returned from the other generative AI by performing network searches based on the determination results, revises and corrects the response, retransmits the corrected response to the other generative AI, and receives a further determination of confidence level and problematic portions; and the learner repeats the operations until a target confidence level is reached and stores a response having an increased confidence level in the learning card.

15 In the integrated learning system, creation of an answer is performed by any of: keyboard input; handwritten input digitized by a scanner; handwriting on a touch panel; and voice input

16 In the integrated learning system, the learner creates and inputs a problem statement based on content understood by the learner.

17 In the integrated learning system, the learner submits the self-created problem statement to the generative AI and evaluates the learner’s own level of understanding by comparing an assumed answer with a response returned from the generative AI; and the response returned from the generative AI is stored in the learning card as an answer to the learner’s question

18 In the integrated learning system, the target examination name, the learning subject, and the selected character string are transmitted to the generative AI, which searches for related past examination questions and lists a plurality of applicable past examination questions.

19 In the integrated learning system, the learner selects and displays one of the listed past examination questions and stores a problem statement in the question section of the learning card, an answer statement in the answer section, and an explanation statement in the remarks section.

20 In the integrated learning system, during a learning-understanding stage, the learner performs text reading, network searches, viewing of explanatory videos, questioning the generative AI, creation of similar problems, and searching for past examination questions, and stores understood content in the form of learning cards; and wherein, when content understood by various methods is stored as learning cards, content of a question section of a created learning card, the target examination name, and the learning subject are transmitted to the generative AI to cause the generative AI to determine a difficulty level of the problem and a probability of appearance in the target examination, and determination results returned from the generative AI are stored in the learning card together with a creation date.

21 In the integrated learning system, when the learner finishes a learning-understanding stage: the learner’s operations during the learning process are transmitted to the generative AI to receive feedback and advice on learning methods; a learning subject and learning items belonging to the learning subject are selected, and a pre-learning organization procedure is executed to create a pre-learning organization table, the pre-learning organization procedure being configured to specify the learning items and, using the Internet or the generative AI, generate an overview of the learning items, key points, advice and cautions regarding learning methods, a list of related web pages with links, and a learning method based on a standard learning time; and the pre-learning organization table includes a learning-method column in which the learning items, the learning methods, and a standard estimated acquisition time based on the learning methods are stored.

22 In the integrated learning system, during a review stage performed by the learner: review is performed by displaying a question section stored in a learning card and allowing the learner to estimate an answer, speak the answer aloud, or handwrite the answer; a created answer is verified by displaying an answer section stored in the learning card and checking whether the stored answer matches the learner-created answer, and, if not matched, correcting the learner’s memory or answering method in accordance with a sensory-motor learning method.

23 In the integrated learning system, review is performed by allowing the learner to answer a problem statement stored in the learning card by voice.

24 In the integrated learning system, review is performed while sequentially displaying the question section, the answer section, and a remarks section of the learning card.

25 In the integrated learning system, display of the question section, the answer section, and the remarks section is performed by button clicks.

26 In the integrated learning system, the learner selects an arbitrary time interval to automatically and sequentially display each of the question section, the answer section, and the remarks section of the learning card, and sequential display of corresponding sections of a next learning card is automatically continued

27 In the integrated learning system, an opening and closing order of the question section, the answer section, and the remarks section is configurable for each learning card.

28 In the integrated learning system, during review, learning cards to be reviewed are extracted based on elapsed time from a creation date of each learning card, the learning cards to be reviewed are extracted according to review timings set based on an Ebbinghaus forgetting curve.

29 In the integrated learning system, immediately after learning, when a savings rate most rapidly decreases on the Ebbinghaus forgetting curve, learning cards created immediately after learning are extracted by performing an AND search using the learning subject and a current date, and the extracted learning cards are continuously displayed for review.

30 In the integrated learning system, learning cards to be reviewed are specified by selecting, from option buttons, card groups created on a creation date, one day after the creation date, three days after the creation date, one week after the creation date, or two weeks after the creation date, or by inputting a date using a calendar-based date time-picker control, and a specific learning card group is extracted based on the specified date.

31 In the integrated learning system, review is performed by repeatedly returning to a first question and continuously displaying the extracted group of learning cards.

32 In the integrated learning system, during a review stage performed by the learner: a past date is selected using a calendar-based date time picker control to specify a DATE-type value, a review period is limited from the specified past date to a current date, and all applicable learning cards are extracted by performing an AND search using a learning-card creation date and the learning subject, under conditions that the creation date is equal to or later than the specified DATE-type value.

33 In the integrated learning system, the learning cards are sortable based on difficulty levels of problem statements stored in the learning cards, and repeated practice using the stored learning cards is performed.

34 In the integrated learning system, the learning cards are sortable in descending order of occurrence probabilities of problem statements stored in the learning cards, and repeated practice using the sorted learning cards is performed

35 In the integrated learning system, during review, problem statements of learning cards that were not answered correctly are extracted, and repeated practice is performed using only the incorrectly answered problems.

36 In the integrated learning system, elapsed time from a stored learning date to a review date and a savings rate are graphed to create a personal forgetting curve, and a personal forgetting curve is generated for each learning method to visualize an efficient learning method.

37 In the integrated learning system, review is performed by clicking a “source text” button included in the learning card to activate an e-book viewer, display content corresponding to a directory stored in the learning card, and return to a source page used at a time of creation of the learning card to confirm described content.

38 In the integrated learning system, review is performed by clicking a “source site” button included in the learning card to activate an Internet browser, display a site corresponding to a URL stored in the learning card, and return to a source site used at the time of creation of the learning card to confirm described content.

39 In the integrated learning system, during a learning‑understanding stage and a review stage, operations performed by learners are monitored, operation information is transmitted to a server, operation data of a plurality of learners are accumulated as big data, and learning behavior tendencies are identified based on the accumulated operation data, whereby improvement points of text content are analyzable.

40 In the integrated learning system, during a learning-understanding stage and a review stage performed by the learner, the learner’s operations are monitored, and points are awarded to each learner according to learning time, a number of created problems, a number of answered problems, and a number of searches, and accumulated points are exchangeable for benefits or prizes

41 In the integrated learning system, the learner pre-registers a learning start time, and when the learner starts studying within a predetermined number of minutes from the registered learning start time and continues studying for a predetermined duration, points are awarded to the learner.

42 In the integrated learning system, the system includes a learning item list table stored in a memory and configured to list learning items for which lessons have been taken.

43 In the integrated learning system, the system includes a textbook learning item list table stored in a memory and configured to list learning items to be learned from a textbook.

### Effects of the Invention

According to the present invention, learning methods can be more effective by being customized to the needs and skills of learners. It enables appropriate and objective evaluation and feedback on learners' learning methods, thereby improving learning outcomes. Detailed feedback can be provided by integrating objective evaluations with learners' self-assessments regarding their learning methods.

Furthermore, generative AI, which has recently attracted attention, can be easily used, learners do not need to have advanced digital literacy, the information is reliable, and it can be used with confidence. It can be easily used by anyone, and learning can be done using the latest technology.

### BRIEF DESCRIPTION OF THE DRAWINGS

FIG. 1 is a diagram illustrating an integrated learning method according to the present invention.

FIG. 2 is a diagram illustrating a configuration of an integrated learning system.

FIG. 3 is a view showing an e-book viewer screen 70.

FIG. 4 is a view showing a settings screen.

FIG. 5 is a view showing an input screen.

FIG. 6 is a view showing a web browser display screen.

FIG. 7 is a view showing a learning card creation screen.

FIG. 8 is a view showing a learning card review setting screen.

FIG. 9 is a view showing a learning card review screen.

FIG. 10 is a flowchart 1-1.

FIG. 11 is a flowchart 1-2.

FIG. 12 is a flowchart 2-1.

FIG. 13 is a flowchart 2-2.

FIG. 14 is a flowchart 3.

FIG. 15 is a flowchart 4.

FIG. 16 is a flowchart 5.

FIG. 17 is a flowchart 6.

FIG. 18 is a flowchart 7.

FIG. 19 is a flowchart 8-1.

FIG. 20 is a flowchart 8-2.

FIG. 21 is a flowchart 9-1.

FIG. 22 is a flowchart 9-2.

FIG. 23 is a flowchart 9-3.

FIG. 24 is a flowchart 10.

FIG. 25 is a flowchart 11.

### DETAILED DESCRIPTION OF THE EMBODIMENTS

In recent years, generative AI technology has advanced remarkably. Support functions using generative AI have been widely deployed in personal computers as part of basic software, generative AI has been integrated with email software, and generative AI, such as open-source ChatGPT, has rapidly become widespread. In educational settings as well, there has been an increasing number of cases in which generative AI is introduced to review instructional design in school education and to improve educational environments. By using generative AI, customized educational materials and assignments tailored to learners’ needs and skill levels can be provided, thereby enabling learners to study at their own pace. In addition, generative AI can be used to automatically evaluate assignments and quizzes and to provide learners with rapid feedback, making it easier for learners to understand their own progress and level of comprehension.

When learning a language, interactive applications using generative AI are available, which can be utilized as conversation partners and can support improvement of pronunciation and grammar. When studying long texts or complex content, generative AI can be used to generate summaries, making it easier to understand the main points. Naturally, learning of different languages and translation are supported, which is useful when learning a new language or deepening cross-cultural understanding. In addition, generative AI can automatically evaluate essays and reports of learners, analyze the quality and content of the writing, and provide appropriate answers to questions from learners, thereby enabling learners to advance self-study and to deepen their understanding more effectively.

Learner progress can be tracked, and reminders or learning advice can be provided as needed. It is also possible to create examination questions, prepare teaching materials, and generate questions for learners.

The present invention is an integrated learning method and system that utilizes these functions of generative AI in a comprehensive manner to improve learning efficiency of learners. In a first step, understanding is achieved; in a second step, memorization (retention) is performed; and in a third step, learner activities are tracked, collected, and stored as big data to further enhance learning efficiency.

Hereinafter, with reference to the drawings, one embodiment of the present invention will be described in detail.

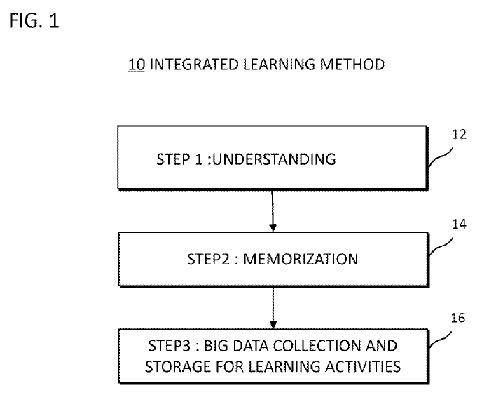

FIG. 1 is a diagram illustrating an integrated learning method according to the present invention. The integrated learning method 10 is divided into three steps: a first step 12 for understanding, a second step 14 for memorization, and a third step 16 for collecting and storing big data of learning activities.

The first step 12 for understanding is a step in which generative AI is mainly utilized to investigate and comprehend a learning item, and the understood content is summarized and stored in a learning card. The learning card includes a question portion, an answer portion, and a remarks portion, and additional items required by the learner can be added. In this step, various methods can be selected for the learner to investigate and understand the learning item. Learning with a specified learning item can be performed not only by reading texts and searching the Internet, but also by viewing explanatory videos or by asking questions to generative AI.

In the first step 12, a learning subject and learning items belonging to the learning subject are selected, and a pre-learning organization procedure is performed to create a pre-learning organization table. The pre-learning organization procedure transmits the specified learning item to a web page accessible by generative AI, and generates an overview of the learning item, key points, advice and cautions regarding learning methods, and a standard learning time. The pre-learning organization table includes a learning method column, in which the learning item, the advice and cautions regarding learning methods created by generative AI, and the standard acquisition time serving as a guideline according to the learning method are stored.

Furthermore, the learner’s hobbies and preferences are transmitted to web pages accessible by a generative AI over the Internet, whereby practical examples and social phenomena related to the learning items are searched. From the search results, web pages and documents associated with the hobbies and preferences input by the learner are preferentially displayed at higher ranks. The learner may then select the web pages and documents to open pages containing detailed descriptions for study. This is intended to enhance the learner’s motivation to learn.

When studying through an e-book viewer or a browser, questions such as points of doubt may be created in the form of text or voice and transmitted together with the learning subject to a generative AI for inquiry. The question text and the answer text returned from the generative AI can be stored in a learning card. In order to verify the reliability of the answer information, the source of the information may also be stored. Along with inquiries to the generative AI, the generative AI itself may generate questions, or alternatively, the learner may create questions by assuming possible answers.

The creation of answers may be performed by the learner through keyboard input, by handwriting on a medium and digitizing the handwriting with a scanner for input, by writing on a touch panel for input, or by voice input. Not limited to the creation of answers, the learner may also create questions by handwriting or by voice input.

The target examination name, the learning subject, and the selected character string may be inserted into a predetermined inquiry template and transmitted to the generative AI, which searches for related past examination questions, lists multiple relevant past questions, and enables the learner to study and store the past‑question text, the corresponding answer text, and the explanatory text. Furthermore, content understood through various learning activities—including reading the text, performing Internet searches, viewing explanatory videos obtained through Internet searches, asking questions to the generative AI, generating similar questions, and searching past examination questions—may be stored in the form of learning cards. When storing understood content in the form of learning cards by any of these methods, the system may transmit the content of the question section of the created learning card, together with the target examination name and the learning subject, to the generative AI, cause the generative AI to determine a difficulty level and appearance probability in the target examination for the created question, and store the returned determination results in the learning card together with the creation date.

In the second step 14 of memorization, the objective is to consolidate the content of the first step 12 of understanding into memory. Human beings are prone to forgetting what has been learned, and the Ebbinghaus forgetting curve is a representative example. The Ebbinghaus forgetting curve, proposed by Hermann Ebbinghaus, is a graph illustrating the relationship between elapsed time and the decline of memory. Through his experiments, Ebbinghaus investigated how information is forgotten after learning and demonstrated that forgetting progresses exponentially with the passage of time. An important lesson derived from Ebbinghaus’s research is that periodic review is required in order to retain information over an extended period. This theory can be utilized to develop effective learning strategies and methods for reinforcing memory.

Review is performed by displaying the question portion stored in a learning card and having the learner generate an answer to the question portion by estimation, vocalization, or handwriting. The generated answer is then compared with the answer stored in the answer portion of the learning card to confirm whether they match. If they do not match, the learner’s memory or answering method is corrected according to a sensory‑motor learning approach.

Sensory‑motor learning refers to a learning process that focuses primarily on the combination of bodily sensation (sensory input) and movement (motor action). Sensory‑motor learning includes several principal elements. In sensory‑motor learning, the learner memorizes movement patterns and constructs motor memory for executing such patterns. Motor memory encompasses neural programs for performing specific motor tasks, and refers to the information and neural mechanisms that store and enable execution of bodily movements and action patterns. Sensory‑motor learning also involves a process of receiving feedback, either through self‑evaluation or external information, and modifying or improving the movement accordingly. Through such feedback, incorrect movements or learning can be corrected, and appropriate movements or learning can be reinforced.

The learning card stores the learning date, thereby enabling repeated review based on the Ebbinghaus forgetting curve. Immediately after learning, when the savings rate decreases most sharply according to the Ebbinghaus forgetting curve, an AND search may be performed within the learning cards using the learning subject and the current date, so that only the learning cards created immediately after learning are extracted. These extracted cards can then be continuously displayed for review.

Furthermore, by inputting a desired word string into the search field, an AND search may be performed within the group of learning cards using both the learning subject and the word string. In this manner, only the cards related to the search string are extracted and can be continuously displayed for review. As a result, multiple questions associated with a specific term or item can be reviewed collectively, and fragmentary knowledge can be retrieved using the keyword as a cue and reconfirmed.

As appropriate review targets, groups of learning cards created today, yesterday, three days ago, one week ago, or two weeks ago may be designated by selecting from option buttons, or alternatively by inputting a date selected in calendar format through a Date Time Picker Control. Based on the designated date, a specific group of learning cards for review can be extracted and reviewed. In this manner, the knowledge understood in the first step 12 can be transferred in the second step 14 from short‑term memory to medium‑term memory and ultimately to long‑term memory, thereby consolidating it within the learner’s brain.

From among the learning cards, a group of cards may be selected as review targets based on conditions such as review date, review period, or learning subject. The extracted group of learning cards may then be repeatedly reviewed by returning to the first question and continuously displaying the cards any number of times. The review date or review period can be designated by selecting a date in calendar format using a Date Time Picker Control. By selecting a past date and specifying DATE‑type data, the review period can be limited from the designated past date up to the present day. An AND search may then be performed using the “creation date of the learning card” stored in the learning card group and the learning subject, so that all learning cards having dates subsequent to the designated DATE‑type value and corresponding to the subject are extracted. The extracted group of learning cards can then be reviewed.

The learning cards may be rearranged for repeated practice based on the difficulty level of the question statements stored therein, or alternatively rearranged based on appearance probability of the question statements stored therein, in which case the cards are ordered in descending order of appearance probability for repeated practice. Furthermore, during review, the question statements of learning cards that were not answered correctly may be extracted, and only those incorrectly answered questions may be subjected to repeated practice again.

Review may be performed by allowing the learner to select an arbitrary time and, at arbitrary time intervals, automatically and sequentially display the question portion, the answer portion, and the remarks portion. The sequential display of each portion of the next learning card may also be continuously and automatically performed. Furthermore, the opening and closing order of the question portion, the answer portion, and the remarks portion can be set arbitrarily for each individual learning card.

By graphing the elapsed time from the stored learning date to the review date together with the savings rate, a self‑forgetting curve can be generated for each learning method. Through such visualization, an efficient learning method suitable for the learner can be identified.

In the third step of collecting and storing big data on learning activities, the operations performed by the learner in the first step and the second step are monitored, and the operation information is transmitted to a server on the network. The operation information data of multiple learners is accumulated, thereby enabling the tendencies of learning behavior to be grasped as big data of the learners as a whole. Based on the identified tendencies of learning behavior, points for improvement of the text content and the like are analyzed. The third step constitutes the most distinctive feature of the present invention.

In the first step and the second step, the operations performed by the learner may be monitored, and points may be awarded to each learner according to factors such as the number of learning hours, the number of questions created, the number of questions answered, and the number of searches performed. Furthermore, the accumulated number of points may be made exchangeable for benefits, prizes, or the like. This serves to enhance the learner’s motivation for learning.

A learning item list table may be provided in which the learning items taught in class are created in the form of a list. By studying with the learning item list table, the content taught in class on that day can be efficiently learned. In addition, a textbook learning item list table may be provided in which desired learning items from a textbook are listed. The textbook learning item list table may be created, for example, when a learner is absent or otherwise unable to attend class, so that the textbook learning items covered in the missed class are listed. By studying with this textbook learning item list table, the learner can make up for the missed class. This is extremely effective in cases where the learner cannot attend class due to hospitalization for illness or participation in various competitions.

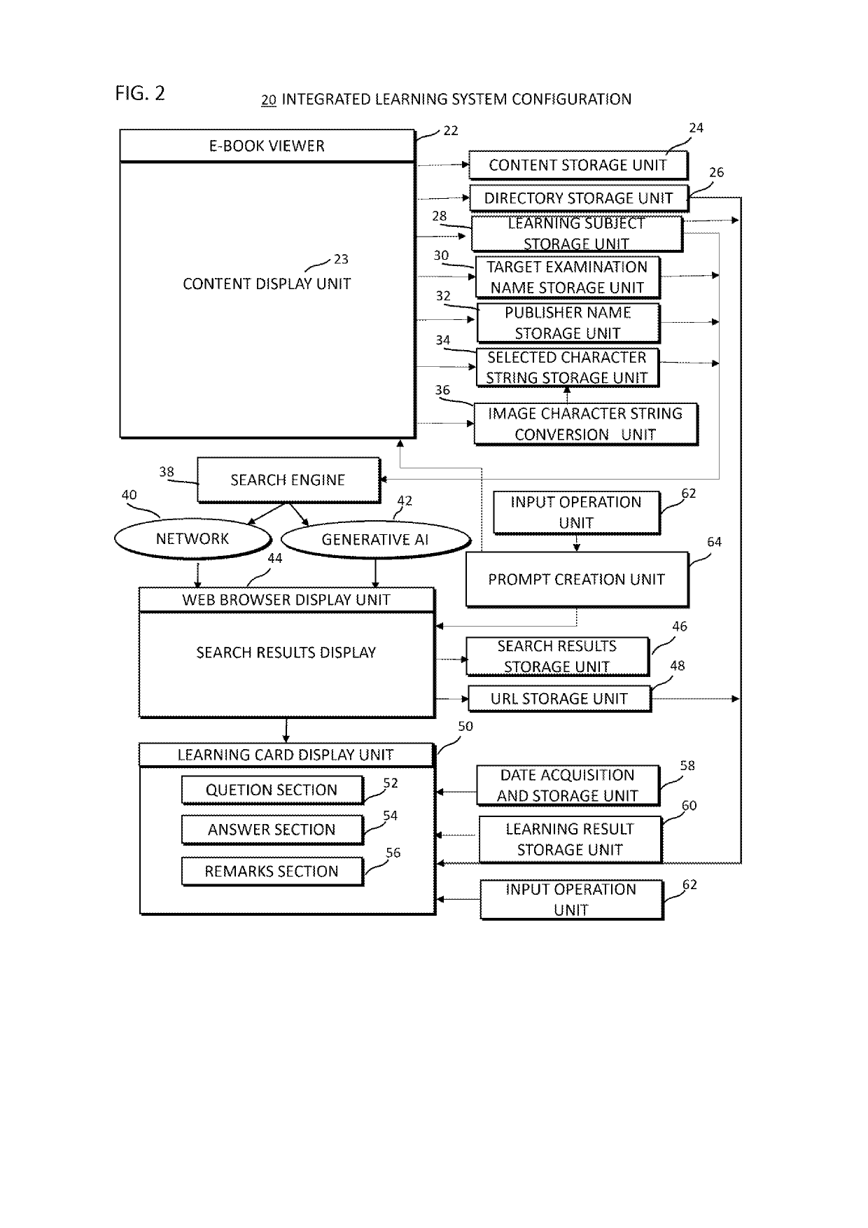

FIG. 2 illustrates the configuration of an integrated learning system. The integrated learning system configuration 20 is composed of an e-book viewer 22, a search engine 38, a network 40, a generative AI 42, a web browser display unit 44, and a learning card display unit 50.

The e-book viewer 22 displays content and other screens on the screen of a content display unit 23. The e-book viewer 22 is further provided with a content storage unit 24, a directory storage unit 26, a learning subject name storage unit 28, a target examination name storage unit 30, a publisher name storage unit 32, a selected character string storage unit 34, an image‑ character string conversion unit 36, an input operation unit 62, and a prompt creation unit 64. The content storage unit 24 stores electronic files of the content of learning items studied. The content is stored as text data or image data. The directory storage unit 26 stores the PC directory of the files used when studying each learning item. The stored directory is copied to the card at the time of card creation, and the source file can be displayed during card review.

The e-book viewer 22 is provided with a function whereby, when a file is selected and opened from a list of e-book files, the learning subject stored within the e-book file is automatically copied and stored in the learning subject name storage unit 28 on the software side. The e-book viewer 22 is further provided with a function whereby, when an e-book file is opened, the “publisher’s name” stored within the e-book file is acquired together with the learning subject stored therein, and stored in the publisher name storage unit 32 on the software side.

The e-book viewer 22 is provided with a function whereby, when an e-book file is opened or when a page is turned, the PC directory in which the electronic content is stored and the page number of the e-book text are acquired from the displayed text page and updated and stored in the directory storage unit 26. A character string within the text page may be selected and stored in the question portion of a learning card. Furthermore, when a search is performed via the network 40 and a website is opened, and a character string from the site is copied and pasted into the answer portion to create a learning card, the data stored in the directory storage unit 26 is stored in the learning card.

The e-book viewer 22 is provided with a function whereby, while studying with text, figures, images, or explanatory videos from a browser displayed on the screen of the content display unit 23, questions such as points of doubt may be created in text or voice format and transmitted together with the learning subject to the generative AI 42. The question text and the answer text returned from the generative AI 42 are then stored in the learning card.

The learning subject name storage unit 28 stores the selected subject of study. Here, the subject of study may be input by users in their native language, for example by entering “Japanese” as the subject. In this manner, even Japanese character strings that cannot be read can be searched simply by selecting them with a mouse, thereby enabling a Japanese dictionary site explained in the user’s native language to be opened.

The learning subject can be set and stored hierarchically. Hierarchical setting refers, for example, to a case in which the learning item “Japanese” is designated as a subject, and a subordinate item “Sports” is set under it, with a further detailed item “Baseball” set beneath “Sports.” This is analogous to the function in household accounting software in which subordinate items such as “Vegetables,” “Meat,” and “Seafood” can be set hierarchically under the item “Food expenses.”

When used by junior high school students, a major item may be set as “Junior High School,” and subordinate items may be set as subjects such as “Japanese Language,” “Classical Literature,” “Mathematics,” “Science,” “Social Studies,” and “English.” For examinees of the Certified Administrative Procedures Legal Specialist examination, a major item may be set as “Administrative Procedures Legal Specialist,” and subordinate items may be set as examination subjects such as “Constitution,” “Civil Law,” and “Local Autonomy Law.” Of course, no setting may be made if no setting is desired.

Further subordinate classifications may also be set. For example, under “Junior High School – English,” a subordinate item “Japanese–English” may be set. This is analogous to household accounting software in which hierarchical settings such as “Food Expenses > Meat > Pork” can be made, which is ordinarily performed in such software. In this manner, when a Japanese character string in an English textbook is selected, the corresponding English word at the junior high school compulsory level can be displayed. For example, when the term government in a sentence is selected with a mouse and the search button is pressed, the set “Junior High School – English – Japanese–English – Government” is searched. As a result, documents relating to educational guidelines of the Japanese government concerning junior high school English are not displayed, but instead the junior high school level translation “government” is displayed.

When it is desired to change the learning subject, the learning subject name storage unit 28 allows the setting screen to be opened, the learning subject to be selected, and combinations of hierarchical learning items to be set or modified.

Once a learning subject has been input and set, the setting can thereafter be changed simply by clicking with a mouse. For example, when English study is completed and the learner wishes to study mathematics next, the setting screen is opened, the junior high school menu is clicked, the subordinate classification “English” is re‑selected as “Mathematics,” the combination is changed to “Junior High School – Mathematics,” and the decision button is clicked to change the setting.

The target examination name storage unit 30 stores the name of the examination that the learner intends to study for. For example, this may be an entrance examination for a prefectural high school in Ibaraki Prefecture, an entrance examination for the XX University YY Faculty, the TOEIC test, or various qualification examinations. It may also be used not only for examinations but for purposes such as specific research or language

The publisher name storage unit 32 stores the information source of the searched information. A constant issue with information on the Internet is its correctness and authenticity. Information provided by AI should be accurate, and it is important that such information be based on facts or cited from highly reliable sources. Accordingly, whether external information or reliable sources are referenced is confirmed and stored. When the generative AI 42 provides an answer with reference to an accurate information source, the accuracy of the answer is enhanced.

The selected character string storage unit 34 stores a character string selected by the learner by dragging with a mouse or the like within an electronic document and clicking the search button, whereby the selected character string is copied and stored. The stored selected character string is transferred to the search engine 38 as a set together with the learning subject stored in the learning subject name storage unit 28 and the publisher’s name stored in the publisher name storage unit 32, and a search is initiated via the network 40, i.e., the Internet. The stored selected character string may also be transferred as a set together with the learning subject stored in the learning subject name storage unit 28 to the generative AI 42, or may be transferred to a website on the network 40 incorporating the generative AI 42. Hereinafter, the generative AI 42 incorporated in a website on the network 40 and the generative AI 42 directly available are both referred to simply as the generative AI 42, since in either case the generative AI 42 is being utilized.

The search results, obtained by searching the stored selected character string together with the learning subject stored in the learning subject name storage unit 28, are displayed in the web browser display unit 44. At the same time, the search results are stored in a search result storage unit 46 provided in the web browser display unit 44. At this time, the URL serving as the information source of the displayed search results is stored in a URL storage unit 48. The search results displayed in the web browser display unit 44 can be processed from the input operation unit 62, that is, corrections or input of additional information can be performed.

The image character string conversion unit 36 is provided with a function whereby, when a learner drags and selects a character image existing in an electronic document of an image data file with a mouse or the like and clicks the search button, the selected character string is converted into editable text data by OCR (Optical Character Recognition) and stored in the selected character string storage unit 34. The learning subject stored in the learning subject name storage unit 28 and the character string are transferred as a set to the search engine 38, and a search is initiated on the Internet.

By means of OCR, it is possible to handle cases in which content is image data or text data, but chapter or section titles are displayed not as font data but as designed image data. Of course, character strings within photographs may also be selected and searched on the Internet.

The input operation unit 62 is connected not only to basic input means for computer operation performed manually with a keyboard and mouse, but also to a pen tablet for handwritten input and a microphone for voice input. Pen tablets are broadly classified into two types: board tablets and liquid‑crystal pen tablets. A board tablet is connected to a computer such that drawings made on the board tablet are reflected on the monitor. In contrast, a liquid‑crystal pen tablet incorporates a liquid‑crystal monitor into the board tablet, allowing direct drawing on the monitor so that digital drawings can be created with the sensation of drawing on paper. Either type of pen tablet may be used.

Handwritten characters input by means of a pen tablet can be converted into text data. For example, when it is desired to convert handwritten characters entered on an iPad® using an Apple Pencil® into text, the memo application “Nebo” may be used. In addition, handwritten characters can be converted into text data using Microsoft® OneNote®.

Handwritten character input may also be performed by writing with a pencil or ballpoint pen on a writable medium such as paper, and reading the writing with a scanner for input. Handwritten character input is used to enhance memory through the act of writing, or to develop writing ability for examinations.

In voice input, text can be entered into the computer by speaking. For example, online speech recognition using the Azure Speech® service may be employed for voice input. To use voice input, it is necessary to connect to the Internet, activate the microphone, and place the cursor in a text box. When voice input is enabled, listening automatically begins. Voice input can also be used for pronunciation practice in language learning. Voice output using a speaker can likewise be utilized for listening practice.

Input is entered through the input operation unit 62 and further input via the prompt creation unit 64 into the e-book viewer or the web browser display unit 44.

The prompt creation unit 64 is configured such that a learner registers, in advance, individual learner information including age and proficiency level. Based on the registered information, the prompt creation unit 64 selects an appropriate template sentence from a plurality of example sentences, applies the learner-registered information to the selected template sentence, and automatically creates a prompt. When the learner inputs a question sentence into the e-book viewer 22 and clicks a question button, the prompt and the question sentence can be transmitted together to a generative AI 42. The individual learner information may further include whether the learner is a student or a working adult, and whether the learner is Japanese or a foreign national.

The prompt creation unit 64 is configured to allow a learner to designate a personal tutor character who responds to the learner’s questions, and a plurality of personal tutor characters can be set. Each of the plurality of personal tutor characters is assigned basic information including expertise, personality, and a standpoint from which responses are expected to be provided. For each of the plurality of personal tutor characters, a character image is created. The designation of a personal tutor character is performed by the learner clicking on the character image of the personal tutor. Based on the designation of the personal tutor character, an appropriate template sentence is selected from among a plurality of example sentences, learner-registered information is applied to the selected template sentence, and a prompt is automatically created. When the learner inputs a question sentence into the e-book viewer 22 and clicks a “question” button, the prompt and the question sentence can be transmitted together to the generative AI 42.

A prompt is an effective means for improving the quality of answers provided by the generative AI 42. By supplying conditions, higher‑quality answers can be obtained from the generative AI 42. Accordingly, in order to create effective prompts, for example, the following methods of prompt creation may be employed.

Specific instructions may be given as background information. This increases the likelihood of reaching the desired information. For example, by “conveying the purpose,” it is possible to clearly indicate what is to be solved, such as in a thesis or a speech. By “specifying a role,” an answer can be provided in the manner of that role. By “specifying the output format,” such as designating the number of characters or requiring three items in bullet points, the output format can be controlled. Furthermore, specific instructions may also be given such as “specifying the level of the answer,” “explaining in a manner understandable to junior high school students,” or “providing an answer in simple Japanese understandable to foreigners, together with a translation into their native language.”

Conditions may be narrowed as conditional information. By doing so, it becomes easier to obtain the expected answer.

The expression method may be specified. By assuming a scene or an intended recipient, a sentence adapted thereto can be incorporated into the prompt.

The format of the answer may also be specified. By requiring the answer to be provided in a particular format, the quality of the answer can be improved. Examples include an answer in list format, an answer in summary format, an answer in detailed explanation format, or an answer in comparative format.

Learner attributes may also be registered in the prompt creation unit 64. As learner attributes, proficiency level, whether the learner is currently a junior high school student, high school student, university student, or working adult, and whether the learner is Japanese or a foreigner, may be registered. Based on the registered content, for example, an appropriate template sentence is selected from multiple example sentences, and prompts under such constraint conditions and various functions are automatically created. When the learner inputs a question sentence into the e-book viewer 22 and clicks the question button, the created appropriate prompt together with the question sentence is transmitted to the generative AI 42. When a new format of prompt appears, the system responds by adding template sentences or by updating and upgrading the software.

As a result, the learner does not need to devise an appropriate prompt and perform key input each time a question is asked, and disparities arising from prompt engineering in the use of AI are eliminated.

The learner may also specify the attributes of the respondent with respect to the generative AI 42. For example, “You are an expert in a certain field,” or “You are a teacher of second‑year junior high school students.” In addition, a condition may be imposed on the generative AI 42 that it is a certain character or expert, thereby enabling learning in a conversational format.

A particular way of thinking or method of reasoning may also be imposed as a condition on the generative AI 42. For example, there is lateral thinking as advocated by Edward de Bono. The term “lateral thinking” was coined in contrast to “vertical thinking.” Vertical thinking refers to so‑called logical thinking, in which a theme or question under consideration is logically developed and explored in depth to obtain an answer. In contrast, lateral thinking is a method of thinking that captures questions or situations from different angles to generate new ideas, and produces intuitive ideas by viewing matters from diverse perspectives. By preregistering in the prompt creation unit 64 a condition that thinking should be performed by lateral thinking, and transmitting this condition together with a question to the generative AI 42, learning in conversational format can be carried out.

Furthermore, Edward de Bono proposed the Six Hats thinking method. The Six Hats thinking method is an idea‑generation approach in which a theme is considered from six perspectives. The six perspectives are objectivity, intuition, negativity, positivity, creativity, and overview, and its greatest feature is that ideas are generated from viewpoints different from ordinary ones. In the Six Hats thinking method, all participants wear hats of the same color and make statements about the theme from the viewpoint corresponding to the color of the hat. The color of the hat changes at fixed time intervals, and participants must always make statements from the viewpoint corresponding to the color of the hat. A characteristic of the Six Hats thinking method is that all participants generate ideas from the same viewpoint in accordance with their respective experience and intelligence.

The six hat colors are white, red, black, yellow, green, and blue. The white hat represents an objective and neutral viewpoint. In this color, opinions are expressed using objective facts and numerical data. The purpose of this color is to collect objective data. No hypotheses are formed and no judgments are made; only opinions based on data are provided. The red hat represents a subjective and intuitive viewpoint. In this color, impressions are expressed through emotions and subjectivity, indicating how one intuitively feels. The purpose is to reveal questions or possibilities that cannot be derived solely from theory, and negative emotions such as dislike are also acceptable. Logical explanation is unnecessary, but instead of vague expressions such as “agree” or “disagree,” specific feelings such as “interesting” or “disappointed” are conveyed.

The black hat represents a negative and pessimistic viewpoint, in which logically negative opinions are expressed. The purpose of the black hat is to explore potential questions and risks, and logical opinions are required. The yellow hat represents a positive and optimistic viewpoint, in which logically positive opinions are expressed, in contrast to the black hat. Unlike the red hat, which also conveys positive impressions but in a subjective manner, the yellow hat is logical. The purpose of the yellow hat is to identify advantages such as favorable aspects and possibilities of the theme.

The green hat represents a creative and innovative viewpoint, in which new alternatives unconstrained by facts or data are sought. The green hat may be regarded as the core of the Six Hats thinking method, and in many cases the final conclusion is derived from a refined version of the green hat opinions. The blue hat represents a viewpoint of process management, overview, and coordination, in which the overall flow is to be comprehended. The role of the blue hat also includes integrating and summarizing ideas at the end. When progress is not proceeding smoothly, the hat may temporarily be changed to blue to organize the discussion and determine what should be done next.

An example of a learning method utilizing the Six Hats thinking method will be described. First, character buttons are created for each of the six hat colors. In addition, the learner may create character buttons by adding new types of teachers conceived by the learner. Examples include a teacher who encourages by praise, a Spartan‑type teacher who motivates through strict exhortation, a passionate teacher, a teacher fond of humor, a teacher who explains by analogy, a teacher who enjoys manga, a teacher who, like Socrates, asks questions to lead students to think, or a modest teacher who honestly responds “I do not know” when no grounds or evidence are available.

A modest teacher who honestly responds “I do not know” when no grounds or evidence are available is important as a countermeasure against hallucination. Hallucination of the generative AI 42 refers to the phenomenon in which the generative AI 42 produces plausible but factually unfounded falsehoods. In particular, such hallucination tends to occur in image generation and text generation, and when image generation or text generation is performed by the generative AI 42, care must be taken to prevent hallucination from occurring.

There are multiple causes of hallucination. Of course, hallucination occurs when the data supplied is incorrect, but it may also occur when the data supplied is outdated, or when a question is asked that the generative AI 42 does not understand, in which case the generative AI 42 may forcibly infer from the training data to produce a result. In particular, results inferred and derived by the generative AI 42 remain only within the realm of inference, and therefore are not necessarily accurate information and are often incorrect.

Countermeasures against hallucination include fine‑tuning, prompt engineering, and embedding. Fine‑tuning is a method in which a pretrained AI model is retrained with different data to improve performance in a specific task. Prompt engineering is a method of devising the question sentence so that hallucination is less likely to occur at the time of input. Embedding is a method in which a specific dataset is provided for learning by the generative AI 42, and answers are created based on that dataset.

However, fine‑tuning and embedding are difficult for learners to perform and require confirmation of content by the learner. Therefore, when the answer is “I do not know,” when the learner has doubts about the answer, or when the learner wishes to investigate further, the learner can select a character string in the answer text with a mouse or the like and click the search button, whereby the “selected character string” together with information such as the “registered subject of study” is transmitted as a set to the search engine 38, and an internet search is performed with the search results displayed in the browser. This function is provided because, when actually consulting multiple references, it is otherwise necessary to take out a dictionary or open a browser and input spelling or characters one by one, which is burdensome. Furthermore, when the learner cannot read kanji, it is not possible to consult a dictionary or perform key input. By enabling such troublesome tasks to be easily completed by character string selection and button click, the learner’s motivation to confirm is enhanced.

The answer of the generative AI 42 may be delegated to another generative AI 42 for verification. Currently available generative AIs 42 include ChatGPT, Bing Chat, Bard (PaLM), LLaMA, Claude, Rinna, and Perplexity.AI, among others. Numerous generative AIs 42 are also under development. A “verification” button may be provided in the answer field where the search results of the web browser display unit 44 are shown, so that the answer can be delegated to another generative AI 42. Furthermore, the generative AI 42 to which the answer is delegated may be specified.

Various specific use cases can be considered. For example, when an answer sentence created by the generative AI 42 is displayed, the user may select a character string to be verified, or select the entire text, and then click the “verification” button. A template sentence requesting “certainty rate determination” and “fact‑checking of document content” is prepared in the prompt creation unit 64, and a prompt is created by applying the learner’s individual information thereto. The created prompt together with the answer sentence generated by the generative AI 42 is transmitted to another generative AI 42. The other generative AI 42 determines the certainty rate of whether the transmitted answer sentence is correct, points out problematic portions that are incorrect, corrects the incorrect portions, and returns a correct answer. The determination result and the problematic portions are then displayed in the web browser display unit 44.

Accordingly, the method of “verification by multiple persons,” which is generally used to avoid human error, can be performed by another system of generative AI 42 to check whether hallucination may have occurred, including the probability of occurrence. In addition, by selecting a problematic character string and clicking the “search” button, a related website, that is, the source, can be confirmed. After confirming the source, the learner may edit the answer sentence and transmit the corrected sentence again to another generative AI 42 to request “certainty rate determination” and “fact‑checking of document content” once more. In this manner, by repeating question → answer → re‑question → re‑answer, the learner can engage in conversational learning, and the learning effect is further enhanced.

By repeating questions and answers with the generative AI 42, the learner can deepen understanding of the subject of study, and the indicator “certainty rate” can be gradually increased. When the “certainty rate” of the answer content has sufficiently increased, the content can be stored in a learning card. Specifically, in the course of interaction with the generative AI 42, a question considered important is selected as a character string, the “copy” button is clicked, the learning card creation screen is displayed, and the “paste” button next to the question section is clicked to paste the selected character string into the question section. Next, the “answer of the generative AI” corresponding to the question section is selected as a character string, the “verification” button is clicked to perform fact‑checking and increase the “certainty rate,” and thereafter the “copy” button is clicked and the “paste” button next to the answer section of the learning card creation screen is clicked to paste the selected character string into the answer section, thereby creating the learning card.

Starting from a vague question, the learner can deepen understanding by repeatedly engaging in questions and answers with the generative AI 42. Thereafter, by reviewing the dialogue, the learner may select the key “portions of the interaction,” and by selecting character strings, copy and paste them into the question section and answer section of a learning card for storage, thereby enabling review.

The prompt creation unit 64 can also be used to predict examination questions. First, the type of examination, for example, a junior high school second‑year first‑semester midterm examination or an entrance examination for XX high school, is input. Next, the subject of study is selected. The individual information registered by the learner and the input content are applied to a template sentence in the prompt creation unit 64 requesting prediction, and transmitted to the generative AI 42. The generative AI 42 then predicts fields or questions likely to be asked in the examination. In addition, the generative AI 42 creates a “prediction summary table.” The prediction summary table includes points and issues that must be mastered, points and issues that should be noted in view of recent trends, and points and issues that should be learned if time permits.

As a result, learners who, before an examination, are at a loss as to where to begin can be provided with clues for examination preparation, thereby preventing them from abandoning study altogether. In addition, students who are already well prepared can be given motivation to further reinforce their study by shedding light on the tasks from another perspective.

The learning card display unit 50 is provided with a display area having fields for a question section 52, an answer section 54, and a remarks section 56. The learning card display unit 50 displays the date acquired by the date acquisition and storage unit 58, the subject of study, and the character string stored in the selected character string storage unit 34 together with the search results from the search engine 38. The character string is displayed in the question section 52, and the search results from the search engine 38 are displayed in the answer section 54. The displayed date, subject of study, character string, and search results are stored in the learning result storage unit 60.

Here, the character string displayed in the question section 52 can be transmitted to the search engine 38 to perform a search again. In addition, a character string can be selected from the text sentence displayed in the answer section 54 and transmitted to the search engine 38 to perform a search.

In the learning content, character string selection from a document displayed in the e-book viewer 22 is not limited to individual words, but can be used to perform searches in various fields such as translation of sentences or related information. This is accomplished by newly inputting a keyword into the question section 52 of the learning card display unit 50 displayed in the e-book viewer 22, and performing a search with the search engine 38.

For example, users can search for related works of the author of a text, historical background, and other relevant information. Additionally, if an Italian is learning Japanese through Japanese texts and becomes interested in Japan, they can search for information about Japanese tourist attractions, cherry blossom spots, Japanese cuisine, and more.

The question section 52 is also used for inputting a question sentence to the generative AI 42. The question sentence may be created by the generative AI 42, for example, as a question about an unknown portion or about an item being studied. The answer section 54 displays the answer to the question in the question section 52. A sentence answered by the generative AI 42 is displayed in the answer section 54. The remarks section 56 displays related information. For example, the source and page of the content displayed in the answer section 54 may be input, or related information such as the background or explanation of the answer may be input. Further, for example, when the question is an English word, an example sentence using that English word may be input. The example sentence may be one created by asking the generative AI 42 to create an example sentence and using the answer provided.

The date acquisition and storage unit 58 can acquire the day on which the learner studied and automatically store it.

The learning result storage unit 60 stores, as a learning card, the question section 52, the answer section 54, the remarks section 56 of the learning card display unit 50, together with the date stored by the date acquisition and storage unit 58.

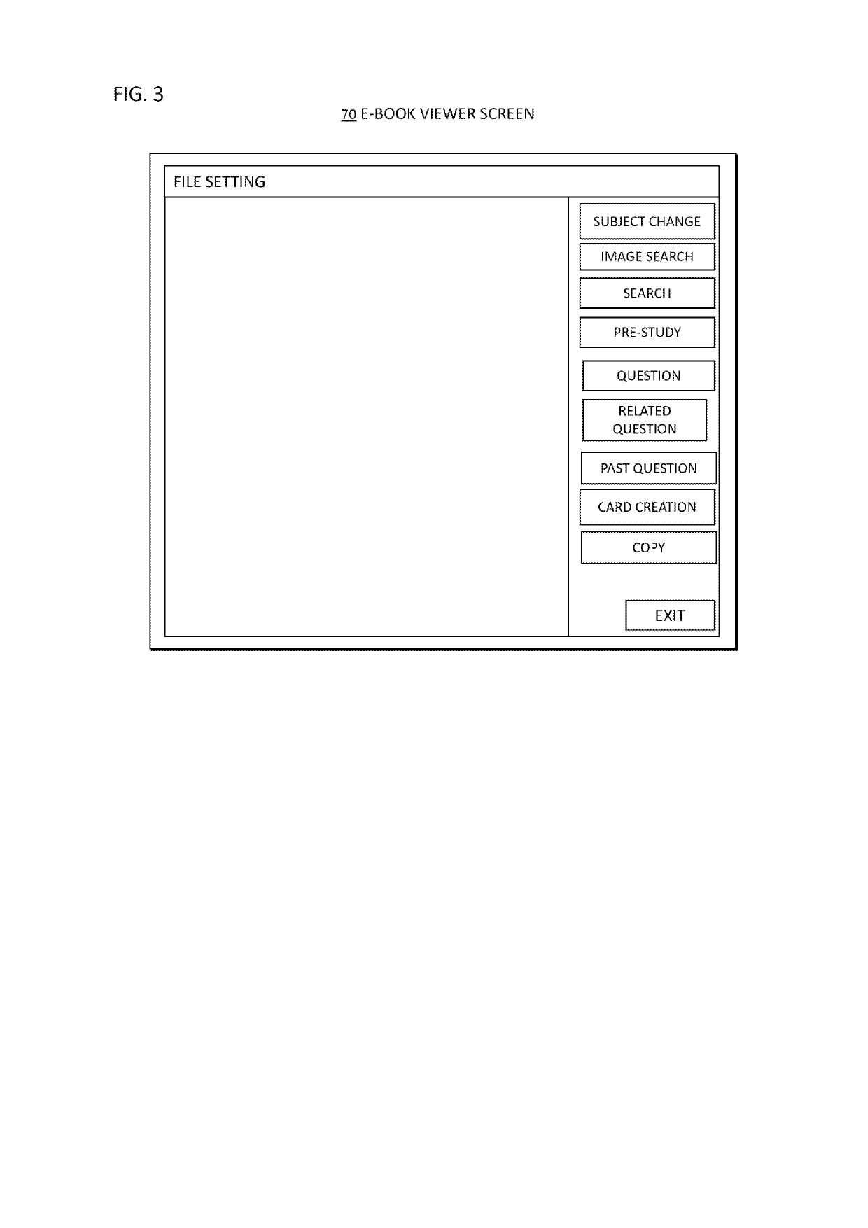

FIG. 3 shows an e-book viewer screen 70. A file set in the file setting is displayed on the display screen of the e-book viewer screen 70. Operation of the display screen is performed by clicking buttons arranged vertically on the right side of the e-book viewer screen 70. The buttons are arranged in order from the top in FIG. 3 as “subject change,” “image search,” “search,” “pre‑study,” “question,” “related questions,” “past questions,” “card creation,” “copy,” and “Exit,” The “subject change” button is for registering or changing the subject of study. The “image search” button is for searching an image character string from the displayed image. The image character string searched by the image search is converted into a text character string by the image character string conversion unit 36.

The “search” function allows a character string of text displayed on the screen to be selected, and when the button is clicked with a mouse or the like, the selected character string together with the stored subject of study and publisher name is transmitted to the search engine to perform a web search on the Internet. The “pre‑study” function allows a character string such as a title within the text to be selected and clicked, whereby the registered subject of study and the learner’s preferences are transmitted to the generative AI 42, which then creates a pre‑study organization procedure list. The pre‑study organization procedure list is displayed in the browser.

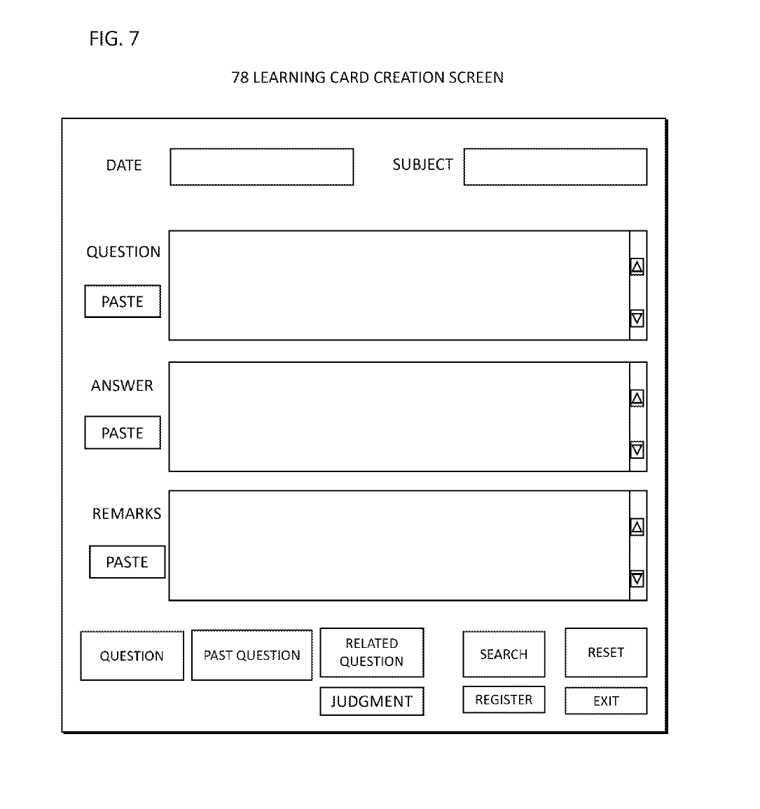

The “question” function is used when, during study of a text or during ordinary Internet searches while viewing figures, photographs, or explanatory videos, a point arises that cannot be understood. When the button is clicked with a mouse or the like, the learning card creation screen 78 shown in FIG. 7 opens, so that a question can be entered in the question field of the learning card creation screen 78. By clicking the question button of the learning card creation screen 78, the question sentence in the question field together with the registered subject of study is transmitted to the generative AI 42, thereby enabling a question to be asked to the generative AI 42. The answer from the generative AI 42 is displayed in the answer field of the learning card creation screen 78. The “question” function is not limited to simply asking about unknown portions, but can also be used, for example, to inquire about and list the etymology of words, kanji characters or foreign words having the same radical or etymology, or English words having the same pronunciation spelling. Furthermore, in the case of translating English into Japanese (English interpretation), errors can be queried and corrected into proper expressions. In addition, in the case of translating Japanese into English by oneself (English composition), grammatical mistakes can be pointed out and corrected into proper English upon request. Thus, the “question” function is a button that is widely used. The question and the answer from the generative AI 42 can be stored directly as a learning card by clicking the “register” button of the learning card creation screen 78.

The “related questions” function is used when asking the generative AI 42 what kinds of questions may be considered in relation to the content being studied. When a character string in the text is selected and this button is clicked, the selected character string together with the stored target examination name and subject of study is transmitted to the generative AI 42, which then creates related questions. The created questions are displayed in the question field of the learning card creation screen 78. When the student writes an answer in the answer field of the learning card creation screen 78 and clicks the judgment button, the created answer is transmitted to the generative AI 42, which determines whether the answer is correct or incorrect. If incorrect, the answer field is cleared and the answer is rewritten, and by clicking the judgment button again, the generative AI 42 can judge the student’s answer any number of times. If correct, the question created by the generative AI 42 and the answer created by the student can be stored in the learning card.

When the answer is already known, that is, when the content is understood, the learner can ask the generative AI 42 what kinds of questions may be posed, thereby learning how questions may be presented in an examination, which is effective as exam preparation. In addition, the learner may formulate questions independently and ask them to the generative AI 42. If the answer differs from the learner’s anticipated answer, the learner considers whether the manner of asking the question was inadequate or whether the understanding was insufficient. This learning method is extremely effective for deepening comprehension.

When the “past questions” button is clicked after selecting a character string in the text, the selected character string together with the stored target examination name and subject of study is transmitted to the generative AI 42. The generative AI 42 searches for and lists past questions that match the content currently being studied in the target examination. Although past question numbers may sometimes be described in the text, for example, when using a nationwide textbook published by a major publisher while aiming for admission to a local high school or university, clicking this button causes past entrance examination questions of the local high school or university to be searched and listed in the Internet browser. From the list, any desired question can be selected and opened, and the question and answer can be copied and pasted into the question section and answer section of the learning card, while the explanatory text of the question can be copied and pasted into the remarks section, thereby storing the content in the learning card. As a result, the tendencies and countermeasures of entrance examination questions of the target school become clear, and the student’s motivation is stimulated.

The “card creation” function can call up the learning card creation screen 78 by clicking. In study texts such as reference books, there may be tables summarizing newly introduced words or columns explaining technical terms. This function is a button for utilizing such information by transcribing it into the question section, the answer section, and the remarks section of the learning card.

By clicking the “card creation” button, the learning card creation screen 78 described later can be called up. After that, newly introduced words or technical terms in the text are selected as character strings, and the “copy” button of the e-book viewer 22 is clicked. Then, by clicking the “paste” button next to the question field of the learning card creation screen 78, the character string selected in the text is transcribed into the question field of the learning card creation screen 78. In the same manner, the corresponding translation or explanatory text in the text is selected as a character string, the “copy” button of the e-book viewer screen 70 is clicked, and the “paste” button next to the answer field of the learning card creation screen 78 is clicked, whereby the translation or explanatory text of the text is transcribed into the answer field of the learning card creation screen 78. In this way, the question section and the answer section of the learning card can be created from the description of the text.

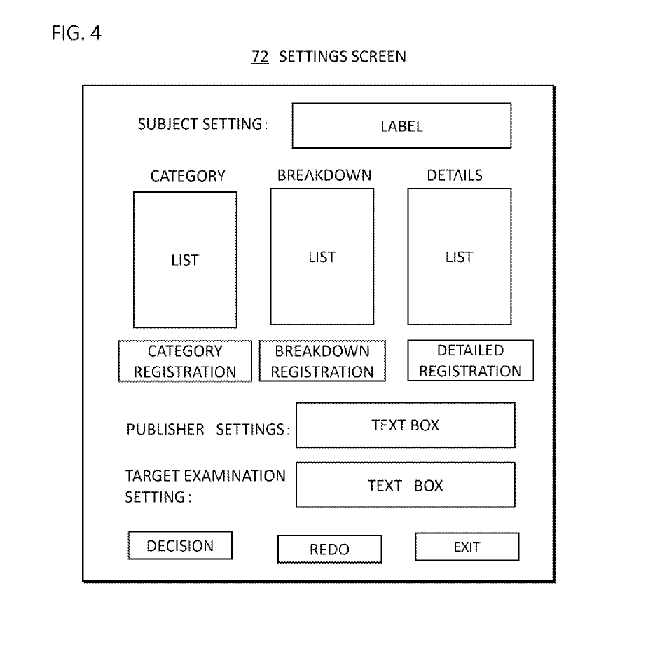

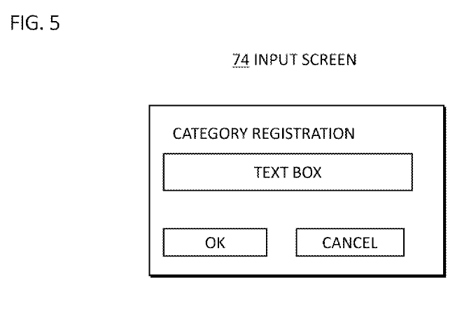

FIG. 4 shows a settings screen 72. This screen appears when the subject change button of the e-book viewer screen 70 shown in FIG. 3 is clicked. In the settings screen 72, first, by clicking the “category registration” button with a mouse or the like, an input screen 74 for category registration as shown in FIG. 5 is displayed. Next, by inputting a subject of study into the Text Box of the input screen 74 using a keyboard or the like and clicking the “OK” button, the input subject of study is registered in the list under the category of the setting screen 72. In the same manner, breakdowns can be listed and registered by clicking the “breakdown registration” button with a mouse or the like. Furthermore, details can be listed and registered by clicking the “detailed registration” button with a mouse or the like. The registered content is reflected in the Label next to the subject setting at the top of the setting screen 72, so the content can be confirmed, and if acceptable, the decision button is clicked. After the initial input by keyboard or the like, the input content remains in the list.

When changing the subject of study, first only the category list is displayed, and the subject of study is selected and clicked from the category list. Then, a breakdown list corresponding to the subject category selected in the category list is displayed. When a character string in the breakdown list is selected and clicked, the detail list corresponding to the breakdown is displayed. By continuing to click and select in this manner, the selected content is reflected in the Label next to the subject settings at the top of the setting screen 72. The content is confirmed, and if acceptable, the decision button is clicked.

In publisher setting, particularly when studying with printed books or the like, the publisher’s name of the study content is input into the publisher setting field using a keyboard or the like. Furthermore, the target examination is input into the target examination setting field using a keyboard or the like. If the above settings are correct, the “decision” button is clicked with a mouse or the like to complete the setting of the study item. If the input content is incorrect, the “redo” button is clicked to correct the erroneous portion.

FIG. 5 shows an input screen 74 for category registration. This screen is used when creating a list in the category field of the setting screen 72 shown in FIG. 4. When the category registration button of the setting screen 72 in FIG. 4 is clicked, the input screen 74 for category registration appears, and a category is input into the text box field of the input screen 74 using a keyboard or the like. By clicking the “OK” button, the input category is entered into the category list field of the setting screen 72. A list can be created by registering categories multiple times. The input screen 74 is also provided for breakdown registration and detail registration, respectively, and operates in the same manner.

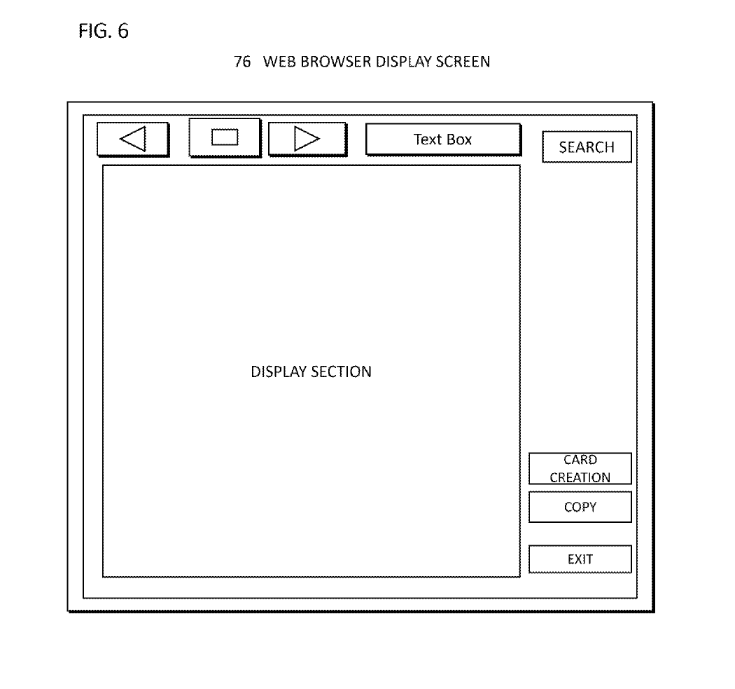

FIG. 6 shows a web browser display screen 76. This screen appears when the “search” button of the e-book viewer screen 70 shown in FIG. 3 is clicked, or when a character string in the text of the e-book viewer screen 70 is selected and the “search” button is clicked. The web browser display screen 76 is a screen for displaying the searched web page. By inputting a keyword into the text box at the top and clicking the “search” button adjacent thereto with a mouse or the like, the keyword can be searched on the Internet.

When it is desired to create a learning card from the information displayed on this screen, the “card creation” button is clicked. Then, the learning card creation screen 78 shown in FIG. 7 is displayed. When a partial character string of the site being displayed is to be copied, the character string on the site is selected with a mouse or the like and the “copy” button is clicked. Next, by clicking the “paste” button adjacent to the desired display field of the learning card creation screen 78, the character string on the site is entered into the selected display field of the learning card creation screen 78. Since multiple web pages are searched, when it is desired to view preceding or subsequent web pages, movement can be performed by the left‑facing triangular arrow and the right‑facing triangular arrow.

When a character string in the text of the e-book viewer screen 70 shown in FIG. 3 is selected and the “search” button is clicked, the web browser display screen 76 of FIG. 6 opens. In this case, when a character string within the searched web page is selected and the “card creation” button is clicked, the learning card creation screen 78 described later opens, and the character string in the text of the e-book viewer screen 70 is automatically entered into the question section of the learning card creation screen 78, while the character string in the web page is automatically incorporated into the answer section. Furthermore, when explanatory text in the web page is selected and the “copy” button is clicked, and the “paste” button adjacent to the remarks section of the learning card creation screen 78 is clicked, explanatory text corresponding to the question and answer can also be incorporated into the remarks section.

Furthermore, when a character string of text in the displayed web page is selected and the “search” button is clicked, the web page is searchable. At the same time that the selected character string is stored as a character code in the selected character string storage unit 34, a search instruction together with the subject of study is transmitted to the search engine 38, and the search is performed via the network 40 by the web browser. The search results are displayed in the display section of the web browser display screen 76.

FIG. 7 shows a learning card creation screen 78. The learning card creation screen 78 includes a date field and a subject field. The date field automatically displays the today’s date. The subject field displays the subject of study set in the setting screen 72.

A learning card is completed with a question, an answer, and remarks; however, the purpose is not the creation of the learning card itself, but rather to use the creation of the learning card as a means for study. Moreover, by creating learning cards in various ways during the learning process, one objective is to achieve understanding and memorization. It is desirable that the learner be able to create learning cards while exploring methods that enable deeper understanding and retention.

In the question field, a question is input. In the answer field, an answer is input. This is the simplest method of creating a learning card. However, in order to achieve deeper understanding and memorization, the question entered in the question field may be asked to the generative AI 42 by clicking the “question” button, and the response may be copied into the answer field, thereby further deepening understanding.

For example, when the English word “have” is input into the question field, a simple learning card can be created by inputting “to possess” into the answer field. However, when “Please explain the meaning of ‘have’ and its usage in English.” is input into the question field and the “question” button is clicked, a query is sent to the generative AI 42, which is ChatGPT, and the following type of response is returned.

“Have” is a very common verb in English and is used in various contexts. Its principal meanings and usages include the following:

1. Indicating possession:

“I have a car.”

“She has two cats.”

2. Indicating experience or condition:

“I have a headache.”

“They have a lot of fun at the party.”

3. Indicating action or state:

“He has breakfast every morning.”

“They have a meeting at 2 PM.”

4. As an auxiliary verb

“I have finished my homework.”

“She has already seen that movie.”

5. Indicating necessity or obligation:

“You have to study for the exam.”

“I have to go to work today.”

6. Indicating past events:

“They had a great time on their vacation.”

“She had a successful career before retiring.”

These are representative usages of “have,” but since the verb carries different meanings depending on context, it must be understood in accordance with the specific usage. It should also be noted that its use differs in negative and interrogative sentences.

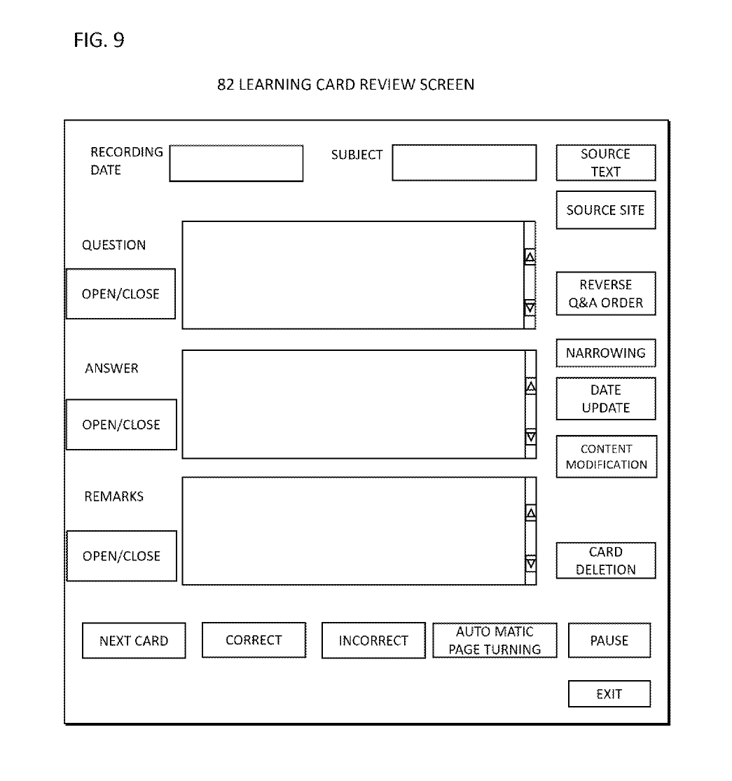

From the answer provided by ChatGPT, the learner may copy the necessary portion and paste it into the answer field. The final note may be pasted into the remarks field. Since scroll bars are provided on the right side of the question field, the answer field, and the remarks field in FIG. 7 and FIG. 9, even long texts can be pasted.

Furthermore, when the learner has a question such as why “has” or “had” appears even though the inquiry was about “have,” and asks the generative AI “What is the difference among ‘have,’ ‘has,’ and ‘had’?,” the generative AI responds with example sentences and an explanation stating that “‘have’ is the general present tense used with singular or plural subjects, ‘has’ is used with a third-person singular subject in the general present tense, and ‘had’ is used in the past tense or past perfect tense to indicate past events or situations.” This may be created as a single learning card.

Input may be performed by voice input, handwriting input, or keyboard input. When voice input is used, it also serves as practice for English pronunciation. When handwriting input is used, the learner can memorize by writing with the hand and further cultivate writing ability for examinations. Since the learner is actually writing answers to questions by hand, it also functions as examination preparation.

When studying particularly with printed books, if a keyword is input into the question field and the “past questions” button is clicked, the registered subject of study and target examination name together with the keyword are transmitted to the generative AI, and past questions previously asked in the target examination are listed in the browser. The “related question” function has the meaning of creating similar questions, and instructs the generative AI 42 to create questions. The learner considers answers to the questions created by the generative AI 42, inputs them into the answer field, and by clicking the “judgment” button, the generative AI 42 can determine whether the answers are correct, and identify any incorrect portions. The incorrect portions are then corrected to form the correct answer.

The “search” function is used when the learner wishes to further search with respect to an answer displayed in the answer field by selecting a character string of the portion to be searched and submitting a question to the generative AI. The learner selects the character string of the portion to be searched and clicks the “search” button with a mouse or the like.

The “reset” function is used when the learner wishes to reset each input field by clicking the “reset” button to clear the fields. When the question and the answer are correctly completed and the learning card is finalized, the learner clicks the “register” button to store the learning card in the learning result storage unit 60. When the learner clicks the “register” button, the content of the question portion together with the stored learning subject and target examination name are transmitted to the generative AI 42, which determines the difficulty level of the question and the probability of the question being asked in the target examination. In the learning result storage unit 60 (database of learning cards), the display content of the learning card creation screen, the difficulty level and appearance probability of the question as answered by the generative AI, and further data from the directory storage unit 26 and the URL storage unit 48 are stored. When the creation of the learning card is finished, the learner clicks the “exit” button to terminate the learning.

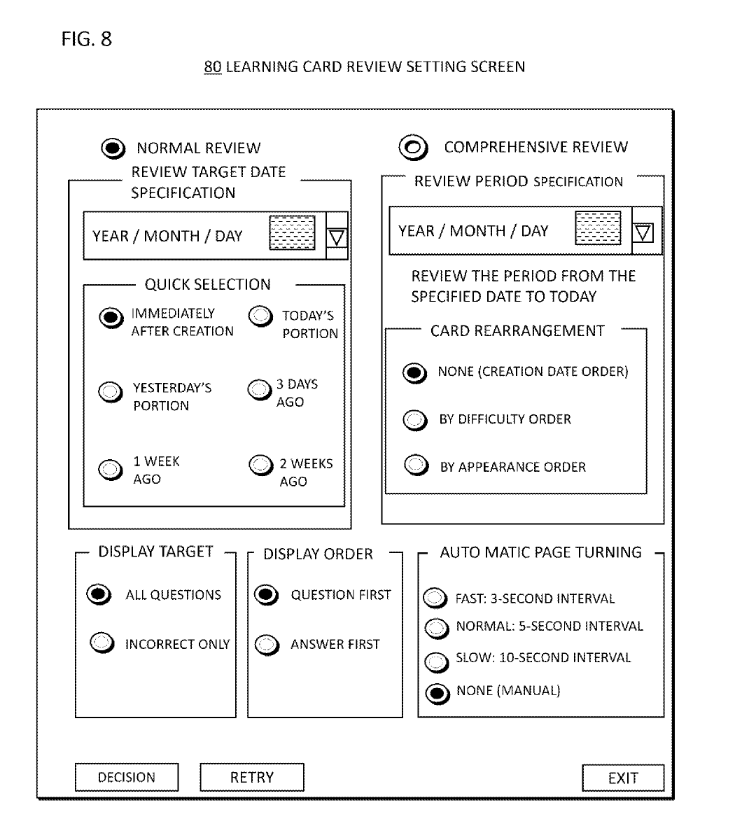

FIG. 8 illustrates a learning card review setting screen 80. The learning card review setting screen 80 includes a normal review and a comprehensive review, and the learner selects either by clicking a selection button. In the review target date specification field, the learner first inputs the review target date into the date field. At this time, the date may be input using a Date Time Picker Control. Alternatively, in a simplified selection field, the learner may select by button “immediately after creation,” “today’s portion,” “yesterday’s portion,” “three days ago,” “one week ago,” or “two weeks ago.”

The reason for limiting the simplified selection to “two weeks ago” is that review of cards created more than three weeks earlier is assumed to be specified by an optional Date Time Picker Control. According to Shion Kabasawa, M.D., in The Complete Guide to Output That Transforms Learning into Results, “As a general guideline, if output is performed three or more times within two weeks after information input, the information is more likely to remain as long-term memory” (p. 25). Based on this, the simplified selection is limited to up to two weeks ago.

In the review period specification field, the learner determines from which past date the learning cards are to be reviewed. The reference date may be input using a Date Time Picker Control. The learning cards can be rearranged, and in the card rearrangement field the learner selects “none (creation date order),” “difficulty order,” or “appearance order.” The difficulty order and the appearance order are performed by sorting the learning cards using, as sort keys, the difficulty values and the appearance probability values stored in the learning result storage unit 60 (database of learning cards).

The display target may be selected by the learner clicking a selection button to choose either “all questions” or “incorrect only.” The display order may be selected by the learner clicking a selection button to choose either “question portion first” or “answer portion first.” Automatic page turning may be selected by the learner clicking a selection button to choose among “fast: 3-second interval,” “normal: 5-second interval,” “slow: 10-second interval,” or “none (manual).” In this way, the learner can freely set the scope and conditions for review, thereby enabling efficient review.

FIG. 9 illustrates a learning card review screen 82. In the learning card review screen 82, the fields “recording date,” “subject,” “question,” “answer,” and “remarks” of the learning cards are displayed in the order set in the learning card review setting screen 80. In the learning card review screen, the learning cards set in the learning card review setting screen 80 are retrieved, the recording date field displays the date on which the learning card was created, the subject field displays the learning subject, the question field displays the question of the learning card, the answer field displays the answer of the learning card, and the remarks field displays the remarks of the learning card.

In the learning card review screen 82, the learning cards set in the learning card review setting screen 80 are displayed, and the question field or the answer field is displayed first according to the selected order. The displayed learning cards are shown in accordance with the selection made in the automatic page turning field of the learning card review setting screen 80. Buttons located at the bottom of the learning card review screen 82 are screen operation buttons. The “pause” button is used to temporarily stop the automatically switched screens at the specified time interval set in the automatic page turning field of the learning card review setting screen 80. The “automatic page turning” button is used to change the time interval of automatic page turning set in the learning card review setting screen 80 or to stop the automatic page turning.

There are three review methods: a test mode, a practice mode, and a confirmation mode. First, in the normal test mode, when the question portion is displayed first, nothing is displayed in the answer portion. The student views the question, assumes an answer, and outputs the answer by writing it on paper or by vocalization. Next, when the “open/close” button beside the answer portion is clicked, the answer portion is displayed, thereby allowing confirmation of whether the answer was remembered. Depending on whether the answer was correct or incorrect, the student clicks either the “correct” button or the “incorrect” button. When all of the selected group of cards in the learning card review setting screen 80 have been judged for correctness, the test mode ends and the practice mode begins. In the practice mode, regardless of whether the answers in the test mode were correct or incorrect, all of the selected group of cards are displayed again starting from the first card.

In the practice mode, correctness judgment is not performed, and the learner proceeds by clicking the “next card” button. In the practice mode, the learner may return to the first card of the selected group any number of times for repeated practice. After memorizing the cards in the practice mode, the learner clicks the “narrowing” button, whereupon the confirmation mode begins, and only the cards that were incorrect in the test mode are continuously displayed. By clicking the “next card” button, the cards are sequentially displayed, and the learner confirms that the answers can now be correctly given, thereby completing the review of the selected group of cards. Since correctness judgment is not performed in the practice mode and the confirmation mode, by clicking the “automatic page turning” button to set the question portion, the answer portion, and the remarks portion to automatically open one after another at several-second intervals, the review can be easily completed.

On the right side of the learning card review screen 82, there are buttons for “source text,” “source site,” “reverse Q&A order,” “narrowing,” “date update,” “content modification,” and “card deletion.” When the “source text” button is clicked, an e-book viewer is activated and the source text is displayed. When the “source site” button is clicked, a web browser is activated and the source site is displayed. The “reverse Q&A order” button is used when the learner has selected the disclosure order in which the question is displayed first; by clicking the “reverse Q&A order” button, the answer will be displayed first from the next time onward.

The “narrowing” function is used when performing review in the confirmation mode after review practice in the test mode and the practice mode. When the learner clicks the “narrowing” button, only the cards that were incorrect in the test mode are narrowed down and displayed, and the learner confirms that the previously incorrect cards can now be correctly answered, thereby completing the review practice. The “date update” function is used when, despite reviewing the created learning cards by the spaced repetition method immediately after creation, before bedtime, the next day, three days later, one week later, and two weeks later, there still appear cards that cannot be memorized. When the learner clicks the “date update” button while such a card is being displayed, the creation date of the card is rewritten to today’s date. As a result, the card returns to the beginning of the spaced repetition schedule and is again extracted by the selection buttons for “today’s portion,” “next day,” “three days later,” “one week later,” and “two weeks later,” thereby becoming a review target again.

The “content modification” function is used when the learner, during review, discovers an error in the description of a card or finds a point that should be changed. By rewriting the description of the card and clicking the “content modification” button, the description of the card can be modified. Conversely, a new question may be created from another perspective, and the contents of the question and the answer may be changed. The “card deletion” function is used when the learner determines that a learning card being reviewed is unnecessary; by clicking the “card deletion” button, the learning card under review is deleted. When the review is to be finished, the learner clicks the “exit” button to terminate the review.

The functions enabled by the above-described integrated learning system configuration may be summarized as follows, and the system is characterized by features that allow effective learning.

An integrated learning system characterized in that: a question statement relating to a selected character string is created by the generative AI 42; the learner creates an answer to the question statement; the generative AI 42 judges whether the answer is correct; until the answer is judged correct, the learner continues to create answers; after the generative AI 42 judges the answer to be correct, the generative AI 42 determines the learner’s level of understanding and weaknesses from the interaction of correct and incorrect answers with the learner, and newly creates and presents a question that the learner should solve next; and the questions, answers, and judgments created by the generative AI 42 can be stored in a learning card.

An integrated learning system characterized in that, in a first step, a part or all of an answer sentence replied by the generative AI 42 is transmitted, together with a prompt requesting judgment as to whether the answer is true and fact-based, to another generative AI of a different system and company, thereby causing the other generative AI to judge the credibility and confidence rate of the content of the answer sentence created by the generative AI 42, to point out problematic portions, and to display the judgment results including the confidence rate and problematic portions in a browser.

An integrated learning system characterized in that, in a first step, after another generative AI of a different system and company has judged the confidence rate and problematic portions of the content of an answer sentence created by the generative AI 42, the learner examines the content of the answer sentence by performing a web search or the like based on the judgment of the problematic portions, corrects the answer sentence, and again causes another generative AI to judge the confidence rate and problematic portions; further, this series of “correction and judgment of the answer sentence” may be repeated any number of times, thereby gradually increasing the target confidence rate, and the answer sentence with increased confidence rate may be used for homework or report preparation or stored in a learning card.

An integrated learning system characterized in that the creation of answers may be performed by the learner inputting with a keyboard, by handwriting on a medium and digitizing with a scanner, by writing on a touch panel, or by voice input; and that question statements may be created and input by the learner himself or herself based on the content understood by the learner.

An integrated learning system characterized in that the learner asks the generative AI 42 about a question statement created by the learner himself or herself, evaluates and judges his or her own level of understanding by comparing the answer with the answer assumed by the learner, and that the answer of the generative AI 42 may be stored as the answer to the learner’s question.

An integrated learning system characterized in that the target examination name, learning subject, and selected character string are transmitted to the generative AI 42, related past examination questions are searched, and multiple corresponding past examination questions are listed; that the learner may select any past examination question from the listed questions and display it; and that the question statement of the displayed past examination question may be copied and pasted into the question portion of a learning card, the answer statement of the past examination question into the answer portion, and the explanation statement of the past examination question into the remarks portion, and stored.

An integrated learning system characterized in that, in a first step, text reading, web searching, viewing of explanatory videos, questioning of a generative AI, creation of similar questions, and searching of past examination questions are performed, and the understood content can be stored in the form of learning cards; when storing the understood content in the form of learning cards by various methods, the content of the question portion of the created learning card together with the target examination name and learning subject are transmitted to the generative AI, which judges the difficulty level of the question of the created learning card and appearance probability in the target examination, and the returned judgment result is stored in the learning card together with the creation date; and when ending the first step, the learner’s operation contents in the learning process are transmitted to the generative AI, and feedback and advice on the learning method can be received.

It is convenient to summarize these as a pre-learning procedure table. By selecting a learning subject and learning items belonging to the learning subject, a pre-learning procedure table is created through a pre-learning organization procedure. The pre-learning organization procedure specifies learning items and uses the internet or a generative AI to create a learning method including an overview of the learning items, key points, advice and cautions on the learning method, and standard learning time. The pre-learning procedure table includes a learning method field, and the learning items, learning methods, and standard acquisition time as a guideline by the learning method can be stored in the learning method field.

An integrated learning system characterized in that, in a second step, review is performed by displaying the question portion stored in a learning card, and the learner creates an answer to the question portion by estimation, vocalization, or handwriting; the created answer is confirmed by displaying the answer portion stored in the learning card and checking whether the learner’s created answer matches the stored answer, and if not matched, the learner corrects memory or answering method, thereby performing review by a sensory motor learning method.

An integrated learning system characterized in that review can be performed by the learner answering the question statement stored in a learning card by voice and inputting the answer by voice; review can be performed while displaying the question portion, answer portion, and remarks portion of the learning card; review can be performed by displaying the question portion, displaying the answer portion, and displaying the remarks portion, and this series of operations can be performed by button clicking.

An integrated learning system characterized in that the learner selects an arbitrary time and automatically sequentially displays each of the question portion, answer portion, and remarks portion of the learning card at arbitrary time intervals, and the sequential display of each portion of the next learning card is continuously automatically displayed; and the opening/closing order of the question portion, answer portion, and remarks portion can be arbitrarily set for each learning card.

An integrated learning system characterized in that, in a second step, the learning date is stored in the learning card and review is repeatedly performed based on Ebbinghaus’s forgetting curve; immediately after learning, when the saving rate decreases most steeply according to the forgetting curve, an AND search is performed among the group of learning cards using the learning subject and today’s date, or the learning subject and a word string, thereby extracting only the learning cards created immediately after creation or only the learning cards related to the word string, and continuously displaying them for review.

An integrated learning system characterized in that, in a second step, appropriate learning cards for review based on Ebbinghaus’s forgetting curve are selected from among the learning cards by choosing card groups created today, yesterday, three days ago, one week ago, or two weeks ago using selection buttons, or by specifying dates through a calendar-type Date Time Picker Control, and based on the specified date, a specific group of learning cards for review is extracted and reviewed.

An integrated learning system characterized in that, in a second step, learning cards are selected by conditions such as review target date, review target period, and learning subject, and the extracted group of learning cards can be repeatedly reviewed any number of times by returning to the first question and continuously displaying them.

An integrated learning system characterized in that, in a second step, a past date is selected by a calendar-type Date Time Picker Control to specify DATE-type data, the review target period is limited from the specified past date to today, and an AND search is performed among the learning cards stored with “creation date of the learning card” and learning subject to extract all learning cards having dates later than the specified DATE-type value and the specified learning subject, thereby enabling comprehensive review of the extracted learning card group; further, the learning cards can be rearranged and repeatedly practiced based on the difficulty level of the question statements stored in the learning cards, and the learning cards can be rearranged and repeatedly practiced in order of higher appearance probability based on the appearance probability of the question statements stored in the learning cards.

An integrated learning system characterized in that, during review, question statements of learning items that were not correctly answered are extracted, and only the questions that were not correctly answered can be repeatedly practiced again.

An integrated learning system characterized in that the elapsed time from the stored learning date to the review date and the saving rate are graphed to create a self-forgetting curve, and the self-forgetting curve can be created for each learning method to visualize efficient learning methods.

An integrated learning system characterized in that review can be performed by clicking the “source text” button in a learning card to activate an e-book viewer, display the contents of the directory stored in the learning card, and return to the source page at the time of creation of the displayed learning card to confirm the described content.

An integrated learning system characterized in that review can be performed by clicking the “source site” button in a learning card to activate an internet browser, display the site URL stored in the learning card, and return to the source site at the time of creation of the displayed learning card to confirm the described content.

For learning software, it is extremely important not only to present learning methods and improve learning effectiveness, but above all to arouse the learner’s motivation. In a survey of junior and senior high school students, 27% responded that they lacked motivation. As a method of arousing learner motivation, a point system is provided. In the first step and the second step, the learner’s operation contents are monitored, and points are awarded to each learner according to learning time, number of questions created, number of questions answered, and number of searches. Furthermore, accumulated points can be exchanged for benefits or prizes.

An integrated learning system characterized in that, in the first step and the second step, the learner registers an arbitrary learning start time in advance, and when the learner begins studying within several minutes from the registered learning start time and continues studying for a fixed period of time, points can be awarded to each learner.

Specifically, the user registers the study start time on a registration screen of a network server, in a smartphone alarm, or in an alarm clock. When the study start time arrives, the smartphone or alarm clock notifies the start time of study, or alternatively, a notification is sent from the server to the smartphone in the manner of an emergency earthquake alert. If study is started within five minutes from the notification and continued for thirty minutes, points are awarded. This is a so-called “welcome point for study.” Of course, even if study is started before the registered start time, points are awarded if thirty minutes of study is performed. Later, when the learner connects to the network server, the registered time data and the learner’s operation content data are collated, and if the operation content data meets the point awarding conditions, points are issued.

Normally, merely notifying the learner of the study start time by a reminder does not arouse motivation. This is because the learner tends to think of excuses not to study and postpones the start of study, often resulting in failure to study at all. However, if the opportunity to obtain points is lost unless study is started within several minutes, the learner has no room for hesitation and cannot postpone. By starting study immediately at the same time every day, the habit of study is naturally acquired, and beginning study no longer becomes burdensome. Thus, with this integrated learning system, anyone can naturally acquire a study habit.

An integrated learning system characterized in that, as a method of arousing learner motivation, when specifying the attribute of the respondent to the generative AI, the learner may designate the name of the respondent, and the generative AI responds under the designated respondent’s name. The designated respondent’s name may be, for example, a famous person, an admired person, a secretly cherished person, or a liked person, specifically designated as someone with whom the learner feels motivated to study. For example, in studying Japanese language, the name of Natsume Soseki may be designated, and responses are given under the name of Natsume Soseki. In studying physics or biology, the name of a Nobel Prize laureate may be designated for responses.

An integrated learning system characterized in that the respondent is not limited to a person, but may also be an animal or a fish. For example, for a person who likes animals, if a panda is designated as the respondent, the learner feels as if studying together with a panda.

Although the answers of the generative AI 42 certainly provide accurate knowledge, the interaction tends to be dry and uninteresting. Therefore, by expressing the name of the respondent in a realistic manner, the learner’s motivation can be stimulated and the willingness to learn can be enhanced.

Next, an example of a learning method using the integrated learning system of the present invention will be described with reference to a flowchart.

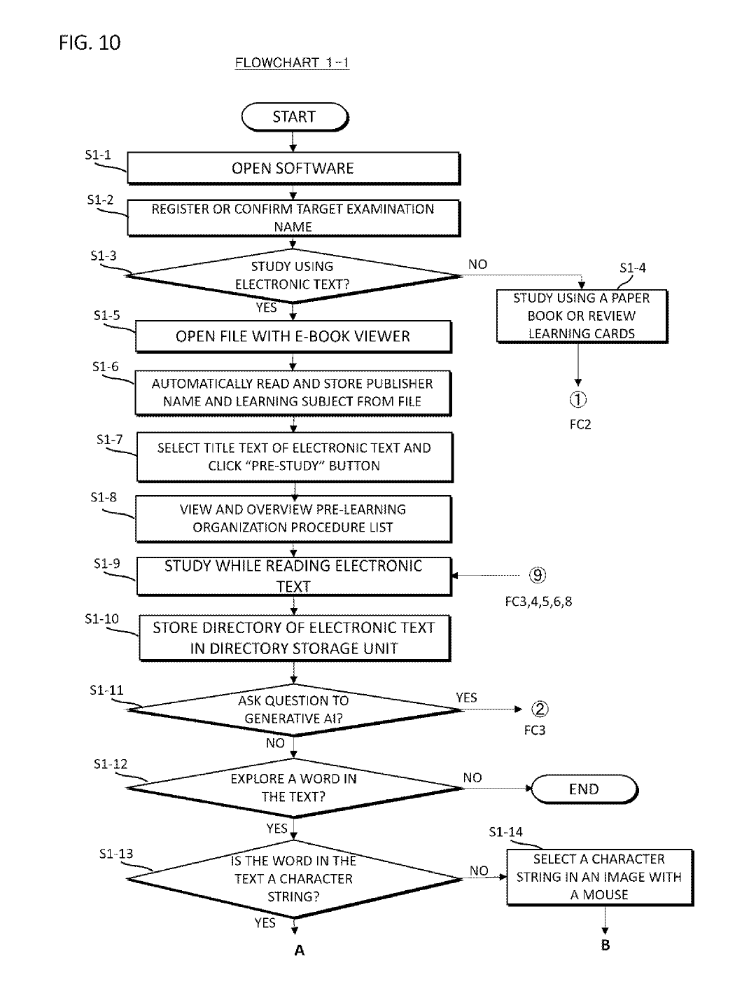

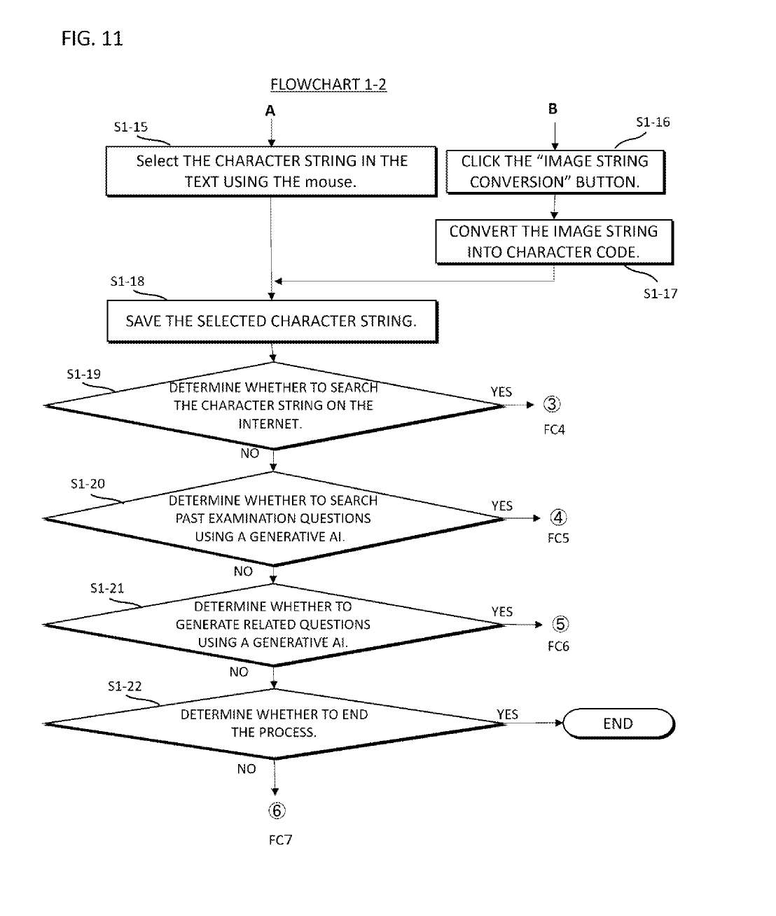

FIG. 10 and FIG. 11 show Flowchart 1. FIG. 10 illustrates Flowchart 1-1, and FIG. 11 illustrates Flowchart 1-2 continuing from Flowchart 1-1. When the learner starts learning, the process begins by opening the software in Step S1-1. When the software is opened, the e-book viewer 22 is displayed. The first stage is preparation study. The target examination name is registered or confirmed (Step S1-2). Then, it is determined whether to study using an electronic text (Step S1-3). If “No,” the learner studies with a paper book or reviews learning cards (Step S1-4) and proceeds to “circle 1” of Flowchart 2. If “Yes,” a file is opened in the e-book viewer 22 (Step S1-5). From the opened file, the publisher name and learning subject are automatically read and stored (Step S1-6).

Automatic setting of the learning subject is performed when a file is selected and opened from the list of e-book files (Open File Dialog) in the e-book viewer 22. The “learning subject” described in the e-book file (e.g., “Junior High School Second-Year English”) is automatically copied and pasted into the learning subject storage unit 28 on the software side. As a result, each time the learner opens an e-book file, the effort of manually inputting the learning subject or selecting from registered subjects is eliminated, and erroneous input is avoided.

Further, when an e-book file is opened in the e-book viewer 22, the “publisher’s name” described in the e-book file is copied together with the learning subject described in the file, and pasted into the publisher name storage unit 32 on the software side.

Accordingly, the learning subject stored in the learning subject storage unit 28 and the publisher’s name stored in the publisher name storage unit 32 are combined with the character string selected on the text, incorporated into parameters for network searching, and transmitted to the search engine 38 via the browser. When the publisher’s name is also included in the search parameters and transmitted to the search engine 38, the homepage of the publisher of the e-book is preferentially displayed at the top of the search results. When the page of the publisher that issued the e-book is preferentially displayed, the correctness of the information can be guaranteed by the credibility of the publisher.

Next, the learner selects the title of the electronic text by mouse and clicks the pre-study button (Step S1-7). As a result, the pre-learning procedure is displayed, and the learner overviews the pre-learning procedure by listing the pre-learning organization table (Step S1-8). After overviewing the list, the learner studies while reading the electronic text (Step S1-9). Note that Step S1-9 may also be reached from “circle 9” of Flowcharts 3, 4, 5, 6, and 8 described later.

The pre-learning organization table is like a map that allows the learner to overview the entire content to be studied before starting study, and is an organized list of issues similar to a pretrial organization procedure, created by the generative AI 42. Even against the doubts or ridicule often expressed by junior and senior high school students, such as “What use is studying this?”, examples of actual use in society are presented in forms tailored to the student’s hobbies and preferences, thereby drawing out the student’s motivation and willingness to study. It can also serve as a guideline for study time.

The pre-learning organization table lists, in bullet points, the important points, correlation diagrams, advice on learning methods, and cautions for the learning item selected as a character string (e.g., relative pronouns, trigonometric functions, Article 16 of the Constitution, chemical formulas). Furthermore, social phenomena related to the learning item are enumerated, focusing on those related to the learner’s hobbies and preferences. When the enumerated titles are clicked, a page with detailed content opens. For example, when “relative pronouns” is clicked, lyrics of Western songs or famous movie lines containing relative pronouns are displayed.

For example, when “trigonometric functions” is selected as a learning item from the text and the “preparation” button is clicked, a list of web pages relating to the history of the discovery of trigonometric functions, structures designed using them, and the mechanism of GPS is displayed. The learner can select a web page of interest and view its detailed content by opening the site. Similarly, when Article 16 of the Constitution is selected and the “preparation” button is clicked, a list of web pages relating to precedents and major incidents associated with Article 16 is displayed. When a chemical formula is selected and the “preparation” button is clicked, a list of web pages relating to stories of the discovery of chemical compositions and methods of manufacturing fertilizers and pharmaceuticals is displayed.

An integrated learning system characterized in that, before the learner begins study, a pre-learning organization procedure is performed to improve learning efficiency. The pre-learning organization procedure is carried out by pre-registering the learning subject, selecting a learning item belonging to the learning subject within the text, and clicking the “preparation” button of the e-book viewer 22. When the learner selects a learning item in the text and clicks the “preparation” button, the registered learning subject, the learner’s hobby and preference information, and the selected character string are transmitted to web pages available to the generative AI 42 on the internet, and the generative AI 42 creates an overview, key points, advice and cautions on learning methods, and standard learning time relating to the selected learning item. The pre-learning organization table includes a learning method field in which the learning item, the advice and cautions on learning methods created by the generative AI 42, and the standard learning time are recorded and stored. Furthermore, a standard acquisition time serving as a guideline by the learning method is provided.

In Step S1-10 of FIG. 10, the directory of the electronic text is stored in the directory storage unit 26 each time the electronic text is opened or a page is turned. When the learner selects a character string from a page displayed in the e-book viewer 22 and searches on the internet, and copies and pastes the displayed information into the answer portion, or copies and pastes the character string of the page into the answer portion to create a learning card, the “directory within the PC = storage location” where the e-book is stored and “which page of the e-book text” are obtained from the directory storage unit 26 and stored in the learning card.

Later, when a question arises during review of the learning card and the learner wishes to return to the text to confirm the description, the learner simply clicks the “source text” button of the displayed card, whereupon the e-book viewer 22 is activated, the e-book in the PC is opened, and the relevant page of the text is displayed, allowing confirmation of the described content. In addition, diagrams and photographs in the text that cannot be included in the learning card can also be reconfirmed by returning to the original text.

In the next Step S1-11, when studying while viewing the electronic text, if there is something unclear or a question, it is determined whether to ask the generative AI 42. If “Yes,” the process proceeds to “circle 2” of Flowchart 3. If “No,” it is determined whether to further explore words in the text (Step S1-12). If “No,” study ends by simply reading the e-book. If “Yes,” it is further determined whether the word in the text is a character string (Step S1-13). If “No,” i.e., in the case of an image character string, the learner selects the character string in the image with the mouse (Step S1-14).

Next, moving to FIG. 11, if “Yes” in Step S1-13 (A), the learner selects the character string in the text with the mouse (Step S1-15). If “No” in Step S1-13, the process proceeds through Step S1-14 (B), and in Step S16 the learner clicks the image character string conversion button. As a result, the image character string is converted into character codes. The selected character string, i.e., the character string in the text and the character codes converted from the image character string, are stored in the selected character string storage unit 34 (Step S1-18).

Next, in Step S1-19, it is determined whether to search the selected character string on the internet. If “Yes,” the process proceeds to “Circled 3” in Flowchart 4. If “No,” it is determined whether to search past examination questions using the generative AI 42 (Step S1-20). If “Yes,” the process proceeds to “Circled 4” in Flowchart 5. If “No,” it is determined whether to create related questions using the generative AI (Step S1-21). If “Yes,” the process proceeds to “Circled 5” in Flowchart 6. If “No,” it is determined whether to end the study (Step S1-22). If “Yes,” study ends. If “No,” the process proceeds to “Circled 6” in Flowchart 7. In this final “No” branch, without asking the generative AI 42, without searching the internet, without searching past questions, and without creating similar questions, the learner creates a learning card by copying and pasting descriptions from the electronic text.

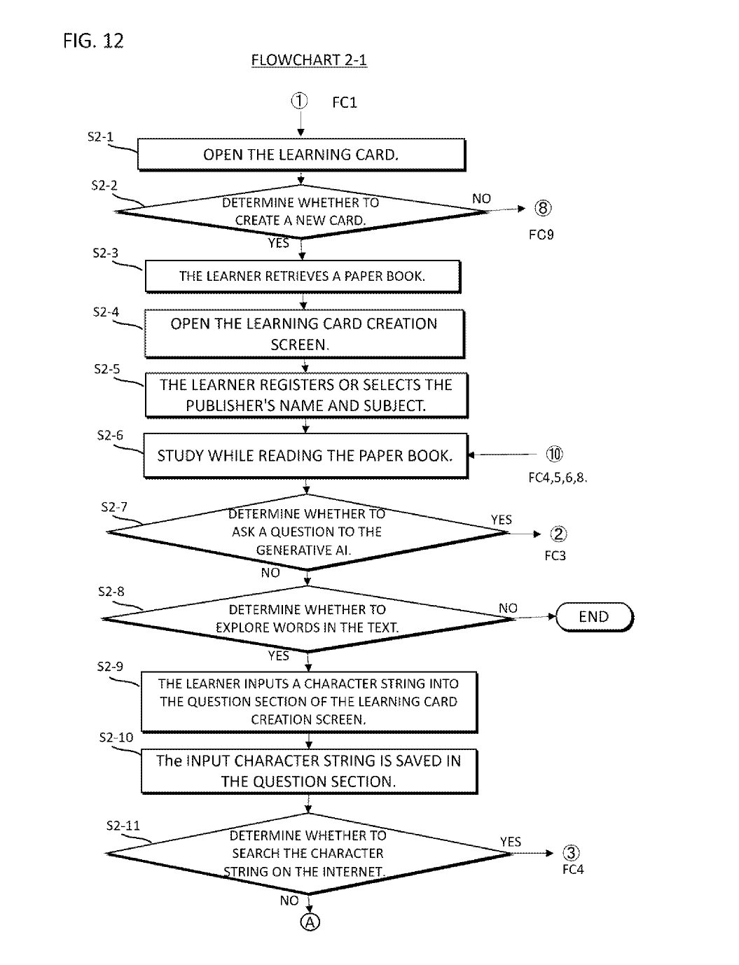

FIG. 12 shows Flowchart 2. Flowchart 2 is for studying with a paper book or reviewing learning cards. Flowchart 2 starts at “Circled 1,” which is reached from “Circled 1” of Flowchart 1. First, in step S2-1, the learner opens a learning card and determines whether to review the opened learning card or create a new learning card (step S2-2). If “No,” the process proceeds to “Circled 8” in Flowchart 9 to review an already created learning card. If “Yes,” the learner takes out a paper book (Step S2-3). Next, the learner opens the learning card creation screen (Step S2-4). Then, the learner registers or selects and sets the publisher name and learning subject (Step S2-5). In Step S2-6, the learner studies while reading the paper book. Step S2-6 may also be reached from Flowcharts 4, 5, 6, or 8.

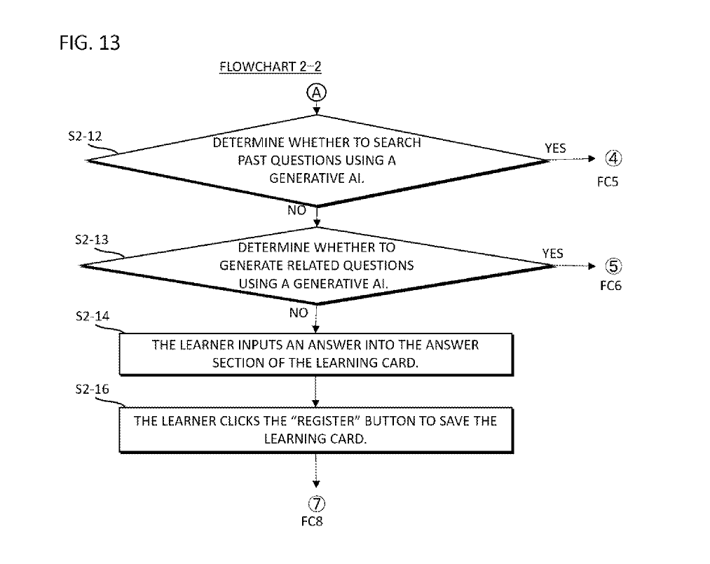

Next, the learner decides whether to ask the generative AI 42 a question (Step S2-7). If “Yes,” the process proceeds to “Circled 2” in Flowchart 3. If “No,” it is determined whether to explore words in the text (Step S2-8). If “No,” study ends with simply reading the paper text. If “Yes,” the learner inputs the string of characters to be explored into the question section of the learning card creation screen 78 (Step S2-9). The string is entered using the keyboard while viewing the paper book. The string entered into the question section is stored in the selected character string storage unit 34 (Step S2-10). Next, it is determined whether to search the string entered in the question section on the internet (Step S2-11). If “Yes,” the process proceeds to “Circled 3” in Flowchart 4. If “No,” the process proceeds to “Circled A” in Flowchart 2-2 in FIG. 13.

In Step S2-12 of FIG. 13, the learner decides whether to search past examination questions using the generative AI 42. If “Yes,” the process proceeds to “Circled 4” in Flowchart 5. If “No,” the learner decides whether to create related questions using the generative AI 42 (Step S2-13). If “Yes,” the process proceeds to “Circled 5” in Flowchart 6. If “No,” the learner inputs an answer into the answer section of the learning card (Step S2-14). The input into the answer section is performed by the learner using the keyboard while viewing the paper book. Once the learning card is created, the learner clicks the register button to register the learning card (Step S2-16). After registration, the process proceeds to “Circled 7” in Flowchart 8.

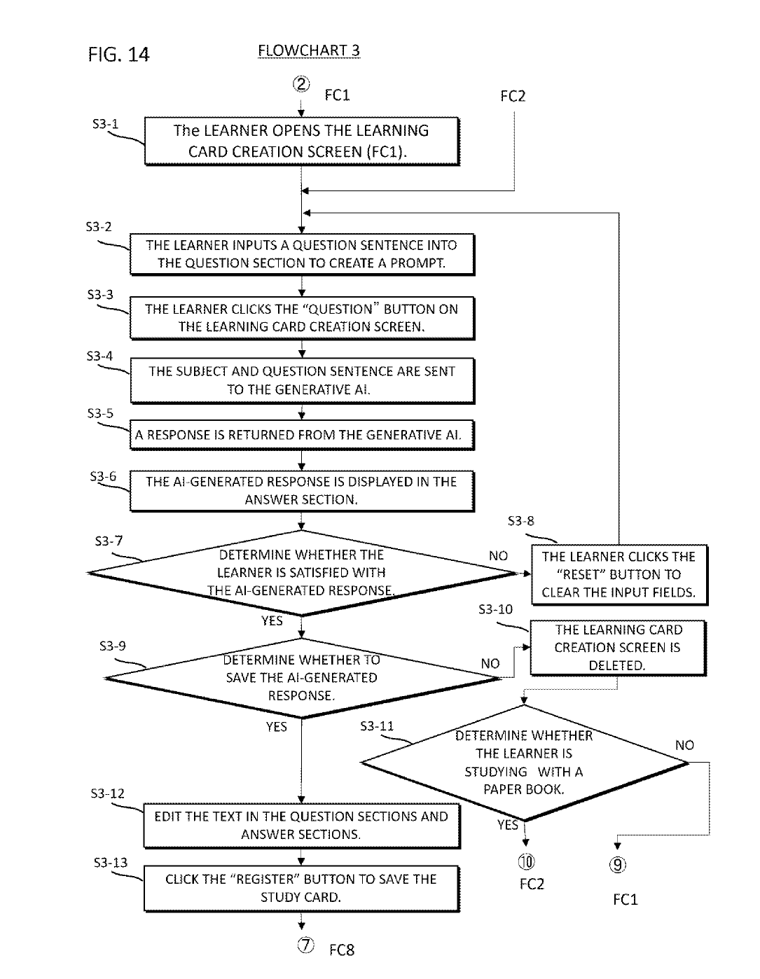

FIG. 14 shows Flowchart 3. Flowchart 3 is the flow for asking the generative AI 42 questions. In this flow, the learner writes a question to a chat-type generative AI 42 (for example, ChatGPT). When the generative AI responds, and the learner clicks a button, the written question is automatically assigned to the question section of the study unit, and the answer from the generative AI 42 is automatically assigned to the answer section of the study unit, and both are stored in the learning card. Thus, a learning card is created and can later be reviewed.

In the flow from “Circled 2” of Flowchart 1, in Step S3-1 the learner opens the learning card creation screen 78. In Step S3-2, including the flow from “Circled 2” of Flowchart 2, the learner inputs a question sentence into the question section of the learning card creation screen 78, and a prompt is automatically created by the program. Then, in Step S3-3, the learner clicks the “question” button of the learning card creation screen 78. As a result, the learning subject, the question sentence of the learning card creation screen 78, and the prompt are transmitted to the generative AI 42, and a question is asked to the generative AI 42 (Step S3-4). In response, an answer is returned from the generative AI 42 (Step S3-5), and the answer of the generative AI 42 is displayed in the answer section (Step S3-6). The learner then judges whether he or she is satisfied with the answer of the generative AI 42 (Step S3-7).

If “No,” the learner presses the “reset” button of the learning card creation screen 78 to clear the fields (Step S3-8), and proceeds to Step S3-2. If “Yes,” the learner judges whether to save the answer of the generative AI 42 (Step S3-9). If “No,” the learner deletes the learning card creation screen 78 (Step S3-10). Then, in Step S3-11, the learner judges whether he or she is studying with a paper book. If “No,” the process proceeds to “Circled 9” of Flowchart 1. If “Yes,” the process proceeds to “Circled 10” of Flowchart 2.

If “Yes” in Step S3-9, the learner edits the wording of the question section and the answer section (Step S3-12), clicks the “register” button of the learning card, and registers the learning card (Step S3-13). Thereafter, the process proceeds to “Circled 7” of Flowchart 8.

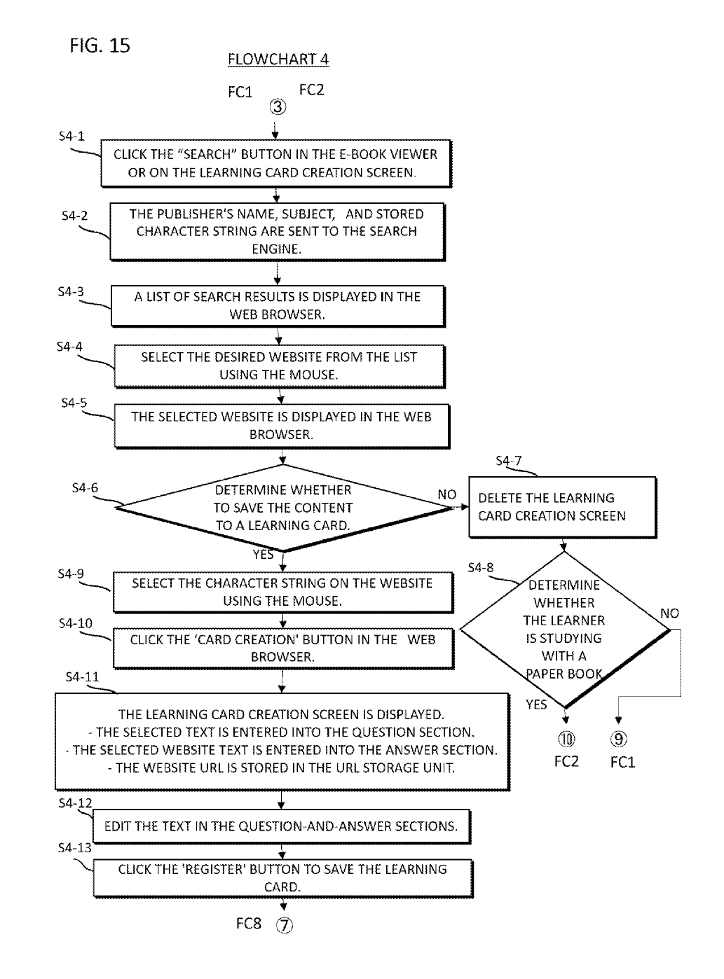

FIG. 15 shows Flowchart 4. Flowchart 4 is the flow for searching words on the internet. Flowchart 4 is the flow from “Circled 3” of Flowchart 1 and Flowchart 2. First, in Step S4-1, the learner clicks the “search” button of the e-book viewer 22 (when coming from Flowchart 1) or of the learning card creation screen 78 (when coming from Flowchart 2). As a result, the publisher name, the learning subject, and the stored character string are transmitted to the search engine 38 (Step S4-2), and a list of search results is displayed on the web browser display screen 76 (Step S4-3).

From the displayed list, when the learner selects by mouse the site he or she wishes to view (Step S4-4), the site is displayed on the web browser display screen 76 (Step S4-5). The learner then judges whether to save the site in the learning card (Step S4-6). If “No,” the learner deletes the learning card creation screen 78 (Step S4-7), and judges whether he or she is studying with a paper book (Step S4-8). If “No,” the process proceeds to “Circled 9” of Flowchart 1. If “Yes,” the process proceeds to “Circled 10” of Flowchart 2.

If “Yes” in Step S4-6, the learner selects a character string on the web site with the mouse (Step S4-9) and clicks the “card creation” button on the web browser display screen 76 (Step S4-10). As a result, the learning card creation screen 78 is displayed, the character string selected in the text is entered into the question section, the character string selected on the site is entered into the answer section, and the site URL is stored in the URL storage unit 48 (Step S4-11). The learner edits the wording of the question section and the answer section of the learning card creation screen 78 (Step S4-12), clicks the “register” button of the learning card (Step S4-13), and registers the learning card. Thereafter, the process proceeds to “Circled 7” of Flowchart 8.

When a character string is selected from a page of the e-book text displayed in the e-book viewer 22, searched on the internet, and a learning card is created, the URL of the web page from which the information was obtained is acquired and stored in the learning card. Later, when a question arises during review of the learning card and the learner wishes to return to the web page to confirm the description, the learner simply clicks the “source site” button in the learning card, thereby activating the browser, opening the web page, and confirming the description of the relevant page. In addition, diagrams, photographs, and pronunciations that cannot be included in the learning card can also be reconfirmed by returning to the web site.

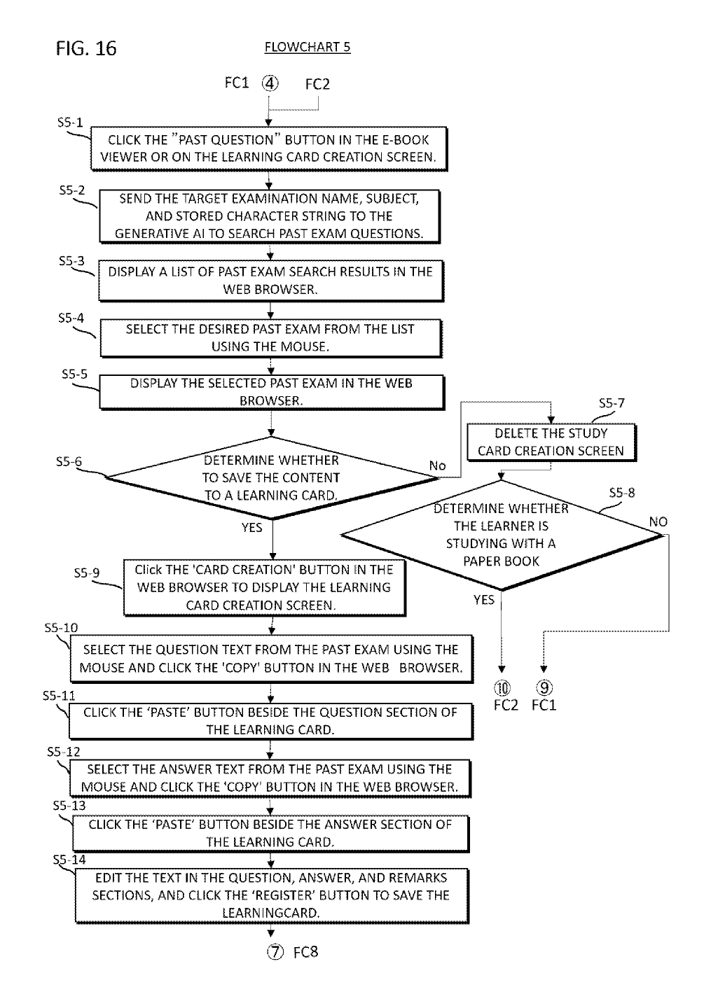

FIG. 16 shows Flowchart 5. Flowchart 5 is the flowchart for searching past examination questions using the generative AI 42. Flowchart 5 is the flow from “Circled 4” of Flowchart 1 and Flowchart 2.

First, in Step S5-1, the learner clicks the “past question” button of the e-book viewer 22 (when coming from Flowchart 1) or of the learning card creation screen 78 (when coming from Flowchart 2). Then, the target examination name, learning subject, and stored character string are transmitted to the generative AI 42 to search past question (Step S5-2), and a list of search results of past question is displayed on the web browser display screen 76 (Step S5-3). From the displayed list, when the learner selects by mouse the past question he or she wishes to view (Step S5-4), the past questions is displayed in the web browser (Step S5-5). The learner then judges whether to save the past question displayed on the web browser display screen 76 into the learning card (Step S5-6). If “No,” the learner deletes the learning card creation screen 78 (Step S5-7). Next, the learner judges whether he or she is studying with a paper book (Step S5-8). If “No,” the process proceeds to “Circled 9” of Flowchart 1. If “Yes,” the process proceeds to “Circled 10” of Flowchart 2.

If “Yes” in Step S5-6, the learner clicks the “card creation” button on the web browser display screen 76 to display the learning card creation screen 78 (Step S5-9). Further, the learner selects the question statement of the past examination question with the mouse, clicks the “copy” button of the web browser display screen 76 (Step S5-10), and clicks the “paste” button beside the question section of the learning card (Step S5-11). Similarly, the learner selects the answer statement of the past question with the mouse, clicks the “copy” button of the web browser display screen 76 (Step S5-12), and clicks the “paste” button beside the answer section of the learning card (Step S5-13). For the explanation of the past examination question, likewise, the learner selects the explanation statement of the past question, clicks the “copy” button of the web browser display screen 76, and clicks the “paste” button beside the remarks section of the learning card to incorporate it into the remarks section of the learning card. Thereafter, the learner edits the wording of the question section, answer section, and remarks section of the learning card, and clicks the register button of the learning card (Step S5-14), thereby registering the learning card. After registration, the process proceeds to “Circled 7” of Flowchart 8.

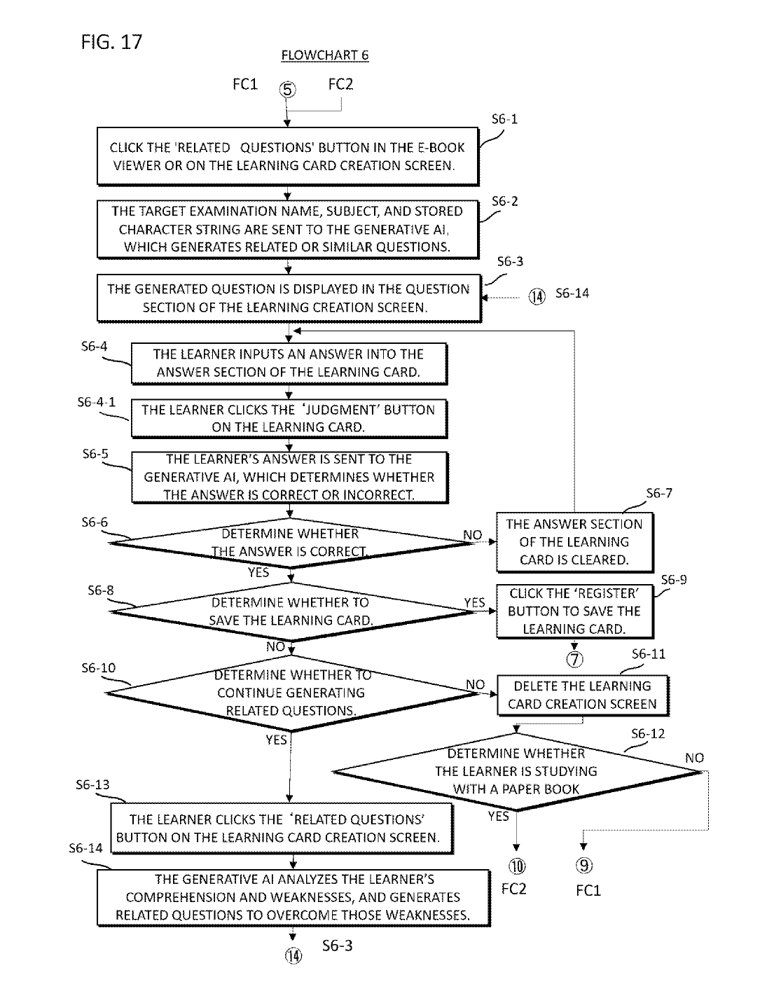

FIG. 17 shows Flowchart 6. Flowchart 6 is the flow for creating related questions using the generative AI 42, and is the flow from “Circled 5” of Flowchart 1 and Flowchart 2.

First, in Step S6-1, the learner clicks the “related question” button of the e-book viewer 22 (when coming from Flowchart 1) or of the learning card creation screen 78 (when coming from Flowchart 2). As a result, the target examination name, learning subject, and stored character string are transmitted to the generative AI 42 (Step S6-2), and the question created by the generative AI 42 is displayed in the question section of the learning card creation screen 78 (Step S6-3).

Next, the learner inputs an answer into the answer section of the learning card creation screen 78 (Step S6-4), and clicks the “judgment” button of the learning card (Step S6-4-1). As a result, the answer created by the learner is transmitted to the generative AI 42, which judges whether the answer is correct or incorrect (Step S6-5). The learner then judges whether the determination by the generative AI 42 is correct (Step S6-6). If “No” (incorrect), the learner deletes the answer field of the learning card (Step S6-7) and returns to Step S6-4. If “Yes” (correct), the learner judges whether to save the learning card (Step S6-8). If “Yes,” the learner clicks the “register” button of the learning card creation screen 78 (Step S6-9), registers the learning card, and proceeds to “Circled 7” of Flowchart 8.

If “No” in Step S6-8, the learner judges whether to continue creating related questions (Step S6-10). If “No,” the learning card creation screen 78 is deleted (Step S6-11). At this time, the learner judges whether he or she is studying with a paper book (Step S6-12). If “No,” the process proceeds to “Circled 9” of Flowchart 1. If “Yes,” the process proceeds to “Circled 10” of Flowchart 2. If “Yes” in Step S6-10, when the learner clicks the “related question” button of the learning card creation screen 78 (Step S6-13), the generative AI analyzes the learner’s level of understanding and weaknesses, creates related questions to overcome the weaknesses (Step S6-14), and the process proceeds to Step S6-3 “Circled 14” of Flowchart 6.

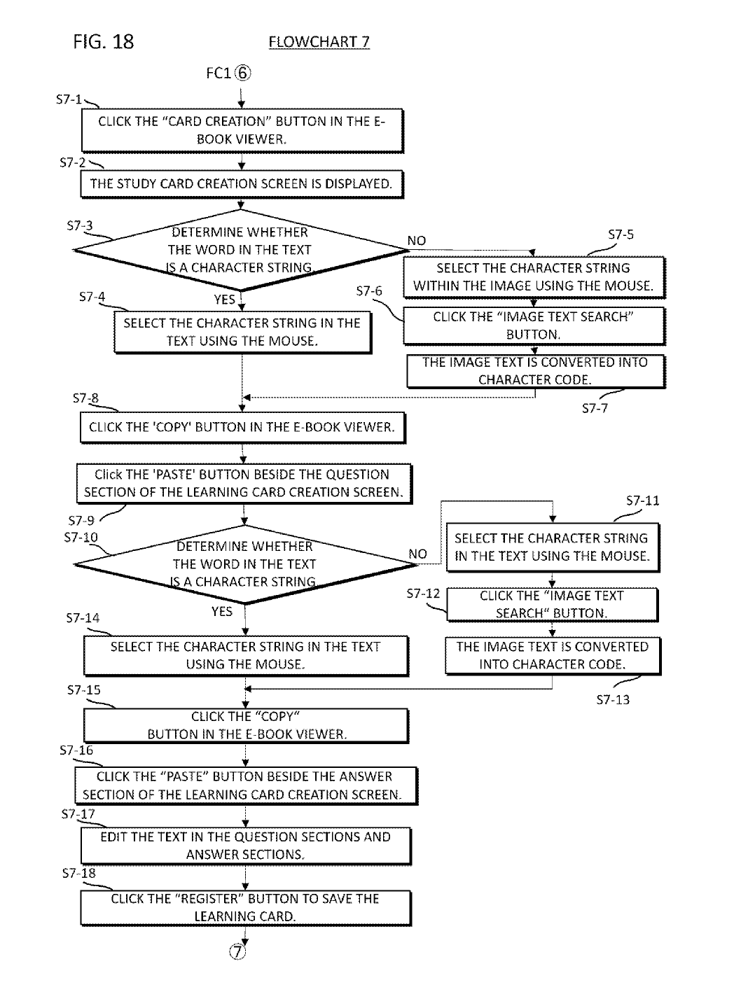

FIG. 18 shows Flowchart 7. Flowchart 7 is the flow for creating learning cards using electronic text, and is the flow from Flowchart 1. This is a method of creating learning cards from descriptions such as summary tables of new words or explanatory columns of technical terms within the electronic text.

First, in Step S7-1, when the learner clicks the “card creation” button of the e-book viewer 22, the learning card creation screen 78 is displayed (Step S7-2). The learner judges whether the word in the text is a character string (Step S7-3). If “Yes,” the learner selects the character string with the mouse (Step S7-4). If “No,” the learner selects the character string in the image with the mouse (Step S7-5) and clicks the image character string search button (Step S7-6), whereby the image character string is converted into character codes (Step S7-7). Next, the learner clicks the “copy” button of the e-book viewer 22 (Step S7-8) and clicks the “paste” button beside the question section of the learning card creation screen 78 (Step S7-9), whereby the character string selected from the text is displayed in the question section of the learning card. Further, the learner judges whether the word in the text is a character string (Step S7-10). If “Yes,” the learner selects the character string with the mouse (Step S7-14). If “No,” the learner selects the character string in the image with the mouse (Step S7-11) and clicks the image character string search button (Step S7-12), whereby the image character string is converted into character codes (Step S7-13).

If “Yes” in Step S7-10, the learner selects the character string in the text with the mouse (Step S7-14). Next, the learner clicks the “copy” button of the e-book viewer 22 for the selected character string or the character codes converted from the image character string (Step S7-15), and clicks the “paste” button beside the answer section of the learning card creation screen 78 (Step S7-16). As a result, the character string selected from the text is displayed in the answer section of the learning card. The learner then edits the wording of the question section and the answer section of the learning card creation screen 78 (Step S7-17), clicks the “register” button of the learning card creation screen 78 (Step S7-18), and registers the learning card. Thereafter, the process proceeds to “Circled 7” of Flowchart 8.

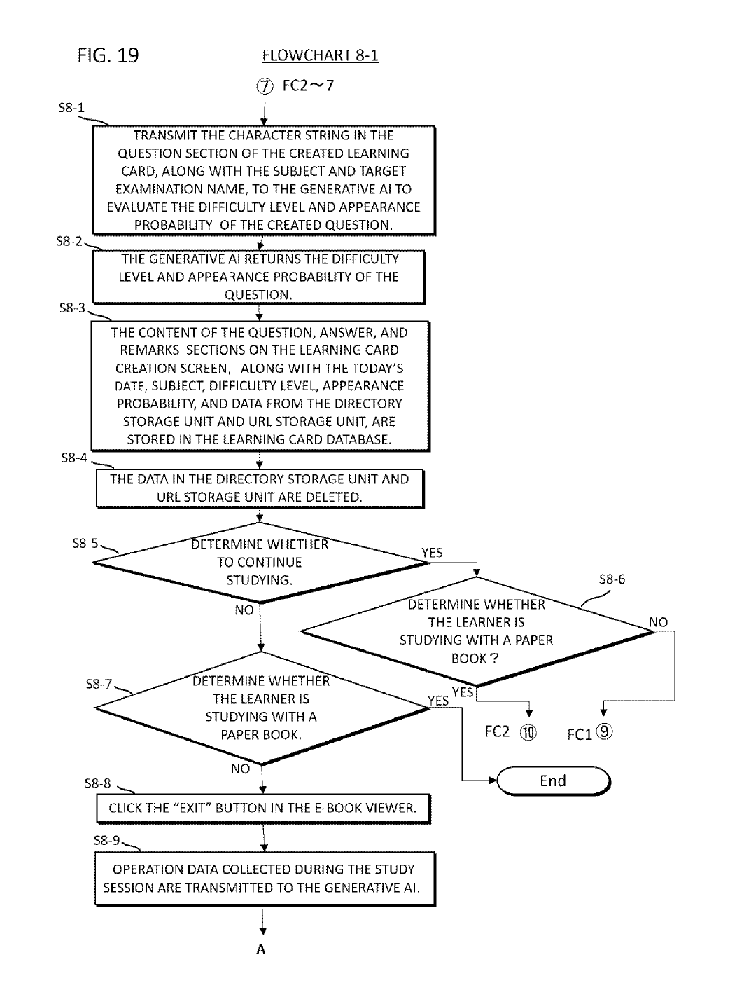

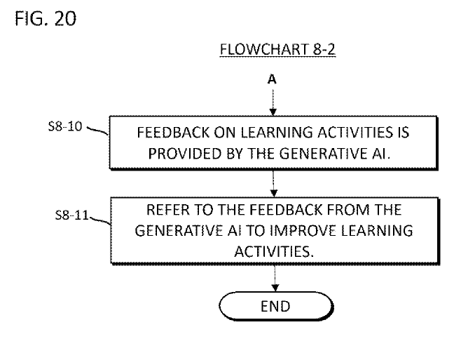

FIGS. 19 and 20 show Flowchart 8. FIG. 19 illustrates Flowchart 8-1, and FIG. 20 illustrates Flowchart 8-2. Flowchart 8 is the flowchart for investigating the difficulty level and appearance probability of questions, and is the flow from “Circled 7” of Flowcharts 2 to 7.

Flowchart 8 corresponds to the sorting functions “difficulty order” and “appearance order card” specified in the card sorting field of the learning card review setting screen 80 shown in FIG. 8. When the learner creates a learning card and clicks the “register” button, the generative AI 42 is caused to estimate the “appearance probability” of the question in qualification examinations or entrance examinations. The estimated probability is automatically stored in the learning card. As the examination approaches, the stored probability values are used as sort keys to rearrange the learning cards, and the learning cards are displayed in descending order of appearance probability, thereby enabling comprehensive review as “appearance order question cards.” In this way, the learner can create “appearance order question cards” using his or her own text in a form suited to his or her own academic ability.

The learner can understand the “importance in the examination” of the study target, thereby gaining motivation to study. Moreover, since the content has already been studied once, review is faster, and forgotten points can be reconfirmed by clicking the “source text” button of the learning card to return to the text. Furthermore, by having the generative AI 42 judge the “difficulty level of the question” and the “importance in learning,” the learning cards can be displayed in ascending order from easy questions to difficult questions, or by importance, thereby enabling systematic review from basic questions to applied questions.

First, Step S8-1 is the flow from “Circled 7” of Flowcharts 2 to 7, in which the character string of the question section of the created information card, the learning subject, and the target examination name are transmitted to the generative AI 42, and the generative AI 42 judges the difficulty level and appearance probability of the created question. The difficulty level and appearance probability of the question are returned from the generative AI 42 (Step S8-2), and the descriptions of the question section, answer section, and remarks section on the learning card creation screen 78, together with today’s date, the learning subject, the difficulty level and appearance probability of the question section, and the data of the directory storage unit 26 and the URL storage unit 48, are stored in the database of the learning card (Step S8-3). Since the data of the directory storage unit 26 and the URL storage unit 48 are stored in the database of the learning card, the data of the directory storage unit 26 and the URL storage unit 48 are deleted (Step S8-4).

Next, the learner judges whether to continue studying (Step S8-5). If “Yes,” it is further judged whether the learner is studying with a paper book (Step S8-6). If “No,” the process proceeds to “Circled 9” of Flowchart 1. If “Yes,” the process proceeds to “Circled 10” of Flowchart 2.

If “No” in Step S8-5, i.e., the learner decides not to continue studying, it is judged whether the learner was studying with a paper book (Step S8-7). If “Yes,” since no operation data was collected during study, study ends. If “No,” since operation data was collected during study, when the learner clicks the “exit” button of the e-book viewer 22 (Step S8-8), the operation data collected during study is transmitted to the generative AI 42 (Step S8-9).

FIG. 20 shows Flowchart 8-2. This is the continuation of Flow A from Flowchart 8-1 of FIG. 19. In Step S8-10, feedback on learning activities is returned from the generative AI 42, so the learner can refer to the feedback on learning activities from the generative AI 42 and improve his or her learning activities (Step S8-11).

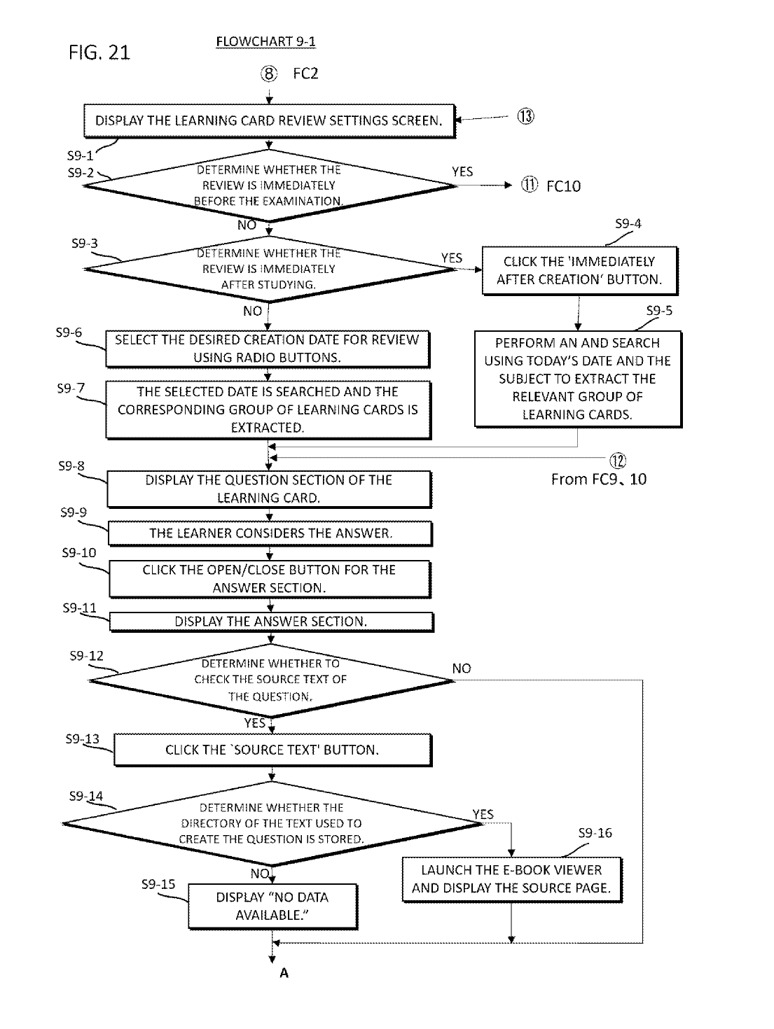

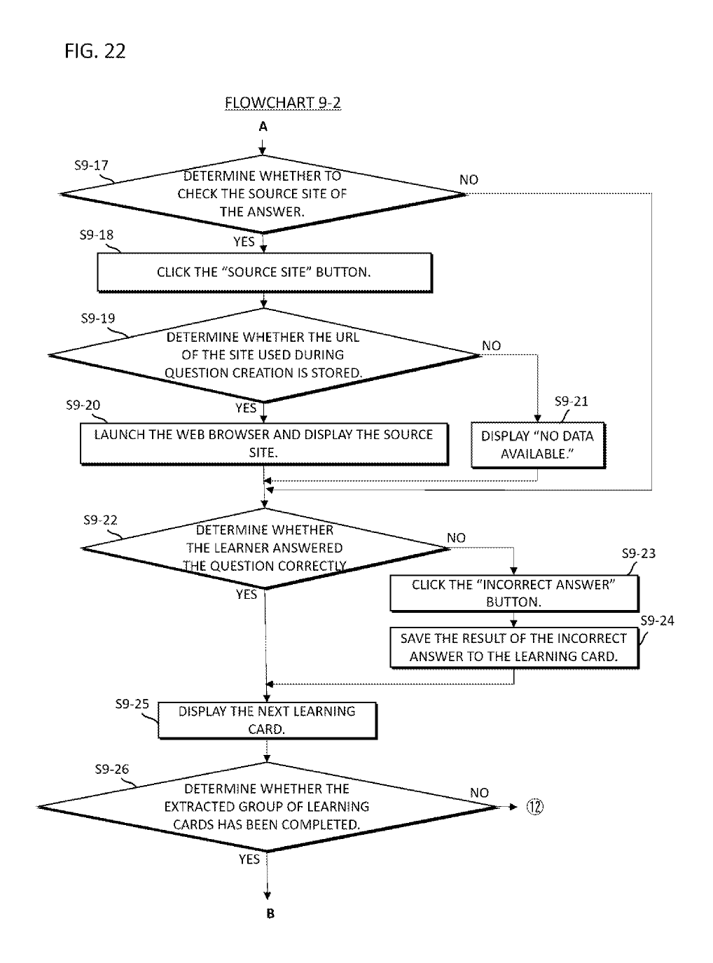

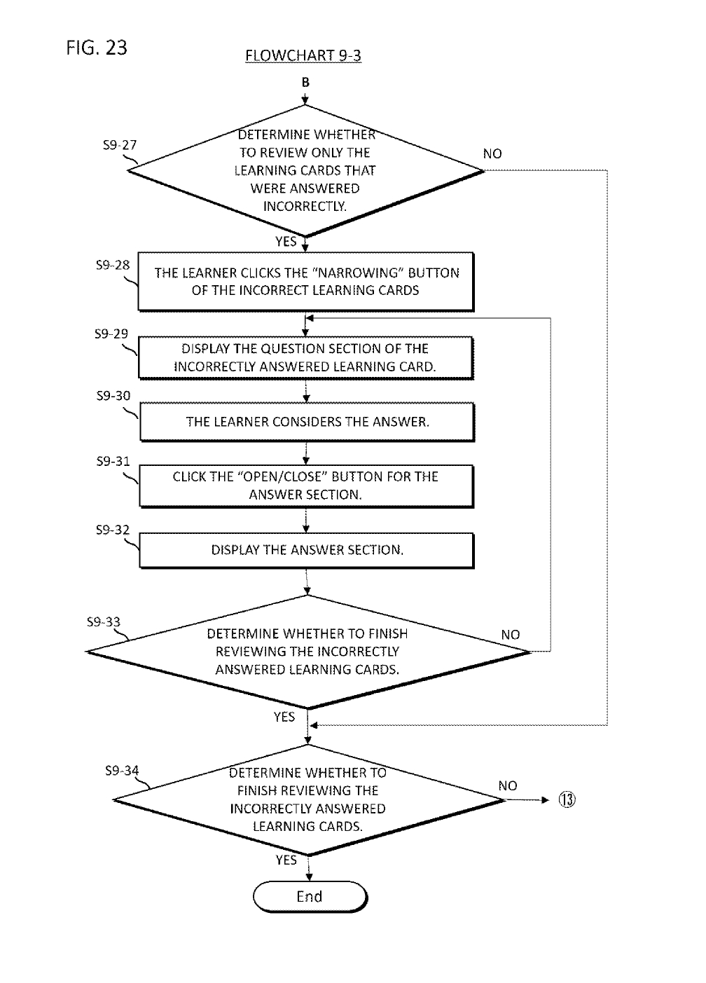

FIGS. 21 to 23 show Flowchart 9. Flowchart 9 is the flow for reviewing learning cards in the second step of memorization. FIG. 21 illustrates Flowchart 9-1, FIG. 22 illustrates Flowchart 9-2, and FIG. 23 illustrates Flowchart 9-3.

Flowchart 9 is the flow from “Circled 8” of Flowchart 2. First, in Step S9-1, the learner displays the learning card review setting screen 80 and judges whether the review is a comprehensive review immediately before the examination (Step S9-2). If “Yes,” the process proceeds to “Circled 11” of Flowchart 10. If “No,” it is further judged whether the review is immediately after study (Step S9-3). If “Yes,” the learner clicks the “immediately after creation” button (Step S9-4), and an AND search is performed using today’s date and the learning subject, or the learning subject and a word string, to extract the corresponding group of cards (Step S9-5). The effect of AND searching the learning subject and word string is that multiple questions related to specific terms or items can be reviewed together, and vague knowledge can be extracted and reconfirmed using keywords as clues.

If “No” in Step S9-3, the learner selects the creation date for review using a radio button or a Date Time Picker Control (Step S9-6). The selected date is searched, and the corresponding group of learning cards is extracted (Step S9-7). Then, the question sections of the learning cards extracted in Steps S9-5 and S9-7 are displayed (Step S9-8). In Step S9-9, the learner considers the answer to the question displayed in the question section, and when the learner clicks the “open/close” button beside the answer section (Step S9-10), the answer section is displayed (Step S9-11). The learner then judges whether to confirm the source text of the question (Step S9-12). If “Yes,” the learner clicks the “source text” button (Step S9-13).

At this point, it is confirmed whether the directory of the text at the time of question creation is stored (Step S9-14). If “No,” “no data available” is displayed (Step S9-15). If “Yes,” the e-book viewer 22 is activated and the source page is displayed (Step S9-16).

FIG. 22 shows Flowchart 9-2, which is the flow from A in FIG. 21. Whether or not the source text is confirmed, and whether or not the source page is displayed, in Step S9-17 the learner judges whether to confirm the source site of the answer. If “Yes,” the learner clicks the “source site” button (Step S9-18), and it is confirmed whether the URL of the site at the time of question creation is stored (Step S9-19). If “Yes,” the web browser is activated and the source site is displayed (Step S9-20). If “No,” “no data available” is displayed (Step S9-21).

Next, the learner judges whether the question was answered correctly, including the case of “No” in Step S9-17 (Step S9-22). If “No,” when the learner clicks the “incorrect” button (Step S9-23), the result of incorrectness is stored in the learning card (Step S9-24). If “Yes” in Step S9-22, and after the result of incorrectness is stored in the learning card in Step S9-24, the next learning card is displayed (Step S9-25). Then, the learner judges whether the extracted learning cards have been completed (Step S9-26). If “No,” the process proceeds to “Circled 12” of Flowchart 9-1.

FIG. 23 shows Flowchart 9-3, which is the flow from B of Flowchart 9-2 in FIG. 22. Step S9-27 is the flow from B of Step S9-26, in which the learner judges whether to reconfirm only the learning cards that were answered incorrectly. If “Yes,” when the learner clicks the “narrowing” button of the incorrect learning cards (Step S9-28), the question section of the incorrect learning cards is displayed (Step S9- 29). The learner then considers the answer (Step S9-30), and when the “open/close” button beside the answer section is clicked (Step S9-31), the answer section is displayed (Step S9-32).

Here, the learner judges whether to end the review of the incorrect learning cards (Step S9-33). If “Yes” in Step S9-33, or “No” in Step S9-27, it is judged whether to end the study. If “Yes,” study ends. If “No,” the process proceeds to “Circled 13” of Flowchart 9-1, and the group of learning cards to be reviewed is changed.

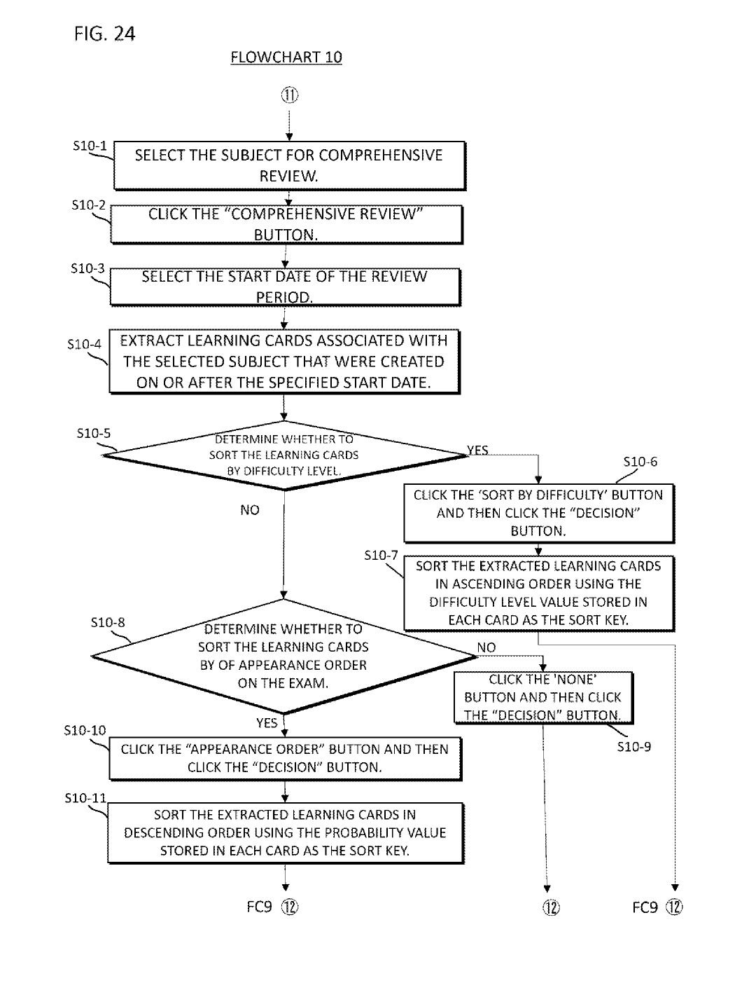

FIG. 24 shows Flowchart 10. Flowchart 10 is the flowchart for comprehensive review of learning cards immediately before an examination. Flowchart 10 is the flow from “Circled 11” of Flowchart 9-1. First, in Step S10-1, the learner selects the learning subject for comprehensive review, and in the learning card review setting screen 80 of FIG. 8 clicks the comprehensive review button (Step S10-2). Next, the learner selects the date on which the comprehensive review period begins (Step S10-3). The date selection is performed using the Date Time Picker Control in the review period specification on the right side of the learning card review setting screen 80, and the target period is from the specified past date to today.

Comprehensive review is performed, for example, as a final check before an examination. The learner selects a past date with the Date Time Picker Control and specifies DATE-type data. From the “card creation date” and learning subject stored in the card group, an AND search is performed using “dates later than the specified DATE-type value” and the learning subject, and all corresponding information cards are extracted and reviewed. In this way, for example, immediately before a midterm test, final test, or certification examination, only the cards of a specific learning subject studied during a specific period (from the specified past date to the present) can be extracted and intensively reviewed.

The learning cards of the specified learning subject created after the specified initial review date are extracted (Step S10-4), and the learner judges whether to sort the learning cards by difficulty level (Step S10-5). If “Yes,” the learner clicks the “difficulty order” button in the “card sorting” box of the learning card review setting screen 80 of FIG. 8 and clicks the decision button (Step S10-6), whereby the extracted learning cards are rearranged in ascending order using the difficulty values stored in the learning cards as sort keys (Step S10-7). After rearrangement, the process proceeds to “Circled 12” of Flowchart 9.

If “No” in Step S10-5, the learner judges whether to sort the learning cards in “appearance order for the examination” (Step S10-8). If “No,” the learner clicks the “none” button in the “card sorting” box of the learning card review setting screen 80 and clicks the “decision” button (Step S10-9). Thereafter, the process proceeds to “Circled 12” of Flowchart 9. If “Yes” in Step S10-8, the learner clicks the “appearance order” button in the “card sorting” box of the learning card review setting screen 80 and clicks the “decision” button (Step S10-10), whereby the extracted learning cards are rearranged in descending order using the appearance probability values stored in the learning cards as sort keys (Step S10-11). Thereafter, the process proceeds to “Circled 12” of Flowchart 9.

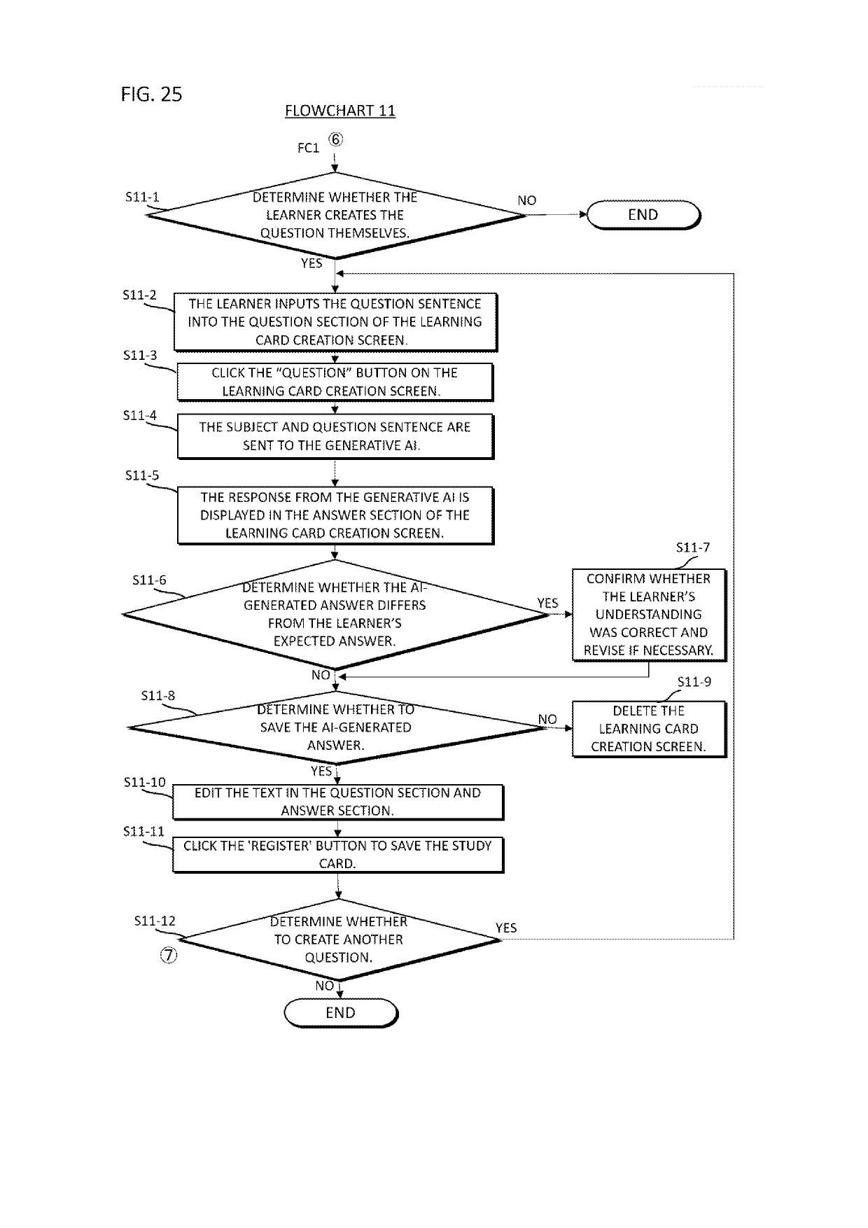

FIG. 25 shows Flowchart 11. In Flowchart 6, related questions are created by the generative AI 42, whereas Flowchart 11 is the flowchart in which related questions are created by the learner himself or herself, and answers are created by the generative AI 42. Flowchart 11 is the flow from “Circled 6” of Flowchart 1.

First, in Step S11-1, it is judged whether the learner himself or herself creates a question (question). If “No,” question creation ends. If “Yes,” the learner inputs a question sentence, i.e., a question statement, into the question section of the learning card creation screen 78 (Step S11-2), and clicks the “question” button of the learning card creation screen 78 (Step S11-3). As a result, the learning subject and the question sentence of the learning card creation screen 78 are transmitted to the generative AI 42, and a question is asked to the generative AI 42 (Step S11-4).

An answer is returned from the generative AI and displayed in the answer section of the learning card creation screen 78 (Step S11-5). The learner then judges whether the answer of the generative AI differs from the learner’s assumed answer (Step S11-6). If “Yes,” since the answer differs from the learner’s assumption, the learner confirms whether the content understood was correct and revises it (Step S11-7). Next, if “No” in Step S11-6, i.e., there was no difference and the answer was correct, then in Step S11-8 the learner judges whether to save the answer including the revised answer of Step S11-7 together with the answer of the generative AI 42. If “No,” the learning card creation screen is deleted (Step S11-9). If “Yes,” the learner edits the wording of the question section and the answer section, clicks the “register” button of the learning card (Step S11-11), and registers the learning card. Thereafter, the process proceeds to “Circled 7” of Flowchart 8, where the difficulty level and appearance probability of the question are judged.

Next, the learner judges whether to create another question sentence (question statement) (Step S11-12). If “Yes,” the process returns to Step S11-2. If “No,” question creation ends.

The embodiments of the present invention have been described above. However, the present invention includes appropriate modifications without impairing its objects and advantages, and is not limited to the embodiments described above.

### Explanation of Reference Numerals

### Explanation of Codes

10 Integrated learning method

12 First step of understanding

14 Second step of memorization

16 Third step of big data collection and storage of learning activities

20 Configuration of integrated learning system

22 E-book viewer

23 Content display unit

24 Content storage unit

26 Directory storage unit

28 Learning subject storage unit

30 Target examination name storage unit

32 Publisher name storage unit

34 Selected character string storage unit

36 Image character string conversion unit

38 Search engine

40 Network

42 Generative AI

44 Web browser display unit

46 Search result storage unit

48 URL storage unit

50 Learning card display unit

52 Question section

54 Answer section

56 Remarks section

58 Date acquisition and storage unit

60 Learning result storage unit

62 Input operation unit

64 Prompt creation unit

70 E-book viewer screen

72 Setting screen

74 Input screen

76 Web browser display screen

78 Learning card creation screen

80 Learning card review setting screen

82 Learning card review screen

1. An integrated learning system comprising:

an e-book viewer configured to select a textbook, reference book, or learning book to be studied and to display content;

a content storage unit configured to store electronic documents;

a directory storage unit configured to store directory information of the content;

a learning subject storage unit configured to register and store learning subjects to be studied;

a target examination name storage unit configured to register and store a name of an examination to be taken;

a selected character string storage unit configured to select and store character strings in a document, the character strings including learning item names, words, technical terms, case numbers, and past examination question numbers;

a selected image character string conversion unit configured to select character images within an image in the document, convert the selected character images into editable text data, and store the converted text data as selected character strings in the selected character string storage unit;

a search engine configured to perform an Internet search using, as one set, the registered learning subject, the target examination name, and at least one of the selected character strings or the selected image character strings;

a network connected to the search engine;

a generative AI accessible via the network and configured to perform the search;

a search result display unit configured to display search results in a web browser;

a search result storage unit configured to store the learning subject, the selected character strings, and the search results;

a URL storage unit configured to store URLs accessed by the web browser;

a learning card display unit configured to display a learning card including a question section, an answer section, and a remarks section;

a learning display unit configured to display a learning screen including a learning-subject section and having a search function and a review function;

a learning result storage unit configured to store results learned in the learning screen as learning cards;

a date acquisition and storage unit configured to acquire and store a date on which learning is performed in the learning screen; and

2. The integrated learning system according to claim 1,

3. The integrated learning system according to claim 1,

wherein the e-book viewer is configured to:

acquire, when an e-book file is opened or when pages are turned, a directory in a PC in which the electronic content is stored and a page number of the e-book text from a displayed text page, and update and store the acquired directory and page number in the directory storage unit; and

4. The integrated learning system according to claim 1,

wherein the e-book viewer is configured to, when a character string is selected from a displayed e-book text page and an Internet search is performed to open a website, acquire a URL of the opened website and store the acquired URL in the URL storage unit; and

5. The integrated learning system according to claim 1,

6. The integrated learning system according to claim 1,

wherein the prompt automatic creation unit is configured to:

register, in advance, individual information of a learner indicating personal attributes including age and proficiency level;

select an appropriate template sentence from among a plurality of example sentences based on the registered information, apply the registered information to the selected template sentence, and automatically create a prompt under constraint conditions;

transmit, when the learner inputs and displays a question sentence on an e-book viewer screen and clicks a “question” button, the prompt together with the question sentence to the generative AI;

allow the learner to designate a personal tutor character defined in the system as an answering entity;

store, for each of a plurality of personal tutor characters, basic information including expertise, personality, and an expected answering standpoint, and corresponding character images;

allow the learner to designate a personal tutor character by clicking a corresponding character image; and

7. The integrated learning system according to claim 1,

wherein:

a problem statement related to the selected character string is generated by the generative AI;

the learner creates an answer to the problem statement;

the generative AI determines whether the answer is correct;

the learner repeatedly creates answers until the answer is determined to be correct;

after the answer is determined to be correct, the generative AI evaluates the learner’s level of understanding and weaknesses based on exchanges of correct and incorrect answers with the learner, and generates and presents a next problem;

the problems, answers, and determinations generated by the generative AI are stored in the learning card;

part or all of a response returned from the generative AI is transmitted, together with a prompt requesting determination of truthfulness or factual accuracy, to a generative AI of a different system or company to determine reliability and confidence level and to identify problematic portions, and determination results including the confidence level and problematic portions are displayed in a browser;

the learner examines the response returned from the other generative AI by performing network searches based on the determination results, revises and corrects the response, retransmits the corrected response to the other generative AI, and receives a further determination of confidence level and problematic portions; and

8. The integrated learning system according to claim 7,

wherein creation of an answer is performed by any of:

keyboard input;

handwritten input digitized by a scanner;

handwriting on a touch panel; and

voice input;

wherein the learner creates and inputs a problem statement based on content understood by the learner;

wherein the learner submits the self-created problem statement to the generative AI and evaluates the learner’s own level of understanding by comparing an assumed answer with a response returned from the generative AI; and

9. The integrated learning system according to claim 1,

wherein the target examination name, the learning subject, and the selected character string are transmitted to the generative AI, which searches for related past examination questions and lists a plurality of applicable past examination questions; and

10. The integrated learning system according to claim 1,

wherein, during a learning-understanding stage, the learner performs text reading, network searches, viewing of explanatory videos, questioning the generative AI, creation of similar problems, and searching for past examination questions, and stores understood content in the form of learning cards; and

11. The integrated learning system according to claim 1,

wherein, when the learner finishes a learning-understanding stage:

the learner’s operations during the learning process are transmitted to the generative AI to receive feedback and advice on learning methods;

a learning subject and learning items belonging to the learning subject are selected, and a pre-learning organization procedure is executed to create a pre-learning organization table,

the pre-learning organization procedure being configured to specify the learning items and, using the Internet or the generative AI, generate an overview of the learning items, key points, advice and cautions regarding learning methods, a list of related web pages with links, and a learning method based on a standard learning time; and

12. The integrated learning system according to claim 1,

wherein, during a review stage performed by the learner:

review is performed by displaying a question section stored in a learning card and allowing the learner to estimate an answer, speak the answer aloud, or handwrite the answer;

a created answer is verified by displaying an answer section stored in the learning card and checking whether the stored answer matches the learner-created answer, and, if not matched, correcting the learner’s memory or answering method in accordance with a sensory-motor learning method;

review is performed by allowing the learner to answer a problem statement stored in the learning card by voice;

review is performed while sequentially displaying the question section, the answer section, and a remarks section of the learning card;

display of the question section, the answer section, and the remarks section is performed by button clicks;

the learner selects an arbitrary time interval to automatically and sequentially display each of the question section, the answer section, and the remarks section of the learning card, and sequential display of corresponding sections of a next learning card is automatically continued; and

13. The integrated learning system according to claim 1,

wherein, during review:

learning cards to be reviewed are extracted based on elapsed time from a creation date of each learning card;

the learning cards to be reviewed are extracted according to review timings set based on an Ebbinghaus forgetting curve;

immediately after learning, when a savings rate most rapidly decreases on the Ebbinghaus forgetting curve, learning cards created immediately after learning are extracted by performing an AND search using the learning subject and a current date, and the extracted learning cards are continuously displayed for review;

learning cards to be reviewed are specified by selecting, from option buttons, card groups created on a creation date, one day after the creation date, three days after the creation date, one week after the creation date, or two weeks after the creation date, or by inputting a date using a calendar-based date time-picker control, and a specific learning card group is extracted based on the specified date; and

14. The integrated learning system according to claim 13,

wherein, during a review stage performed by the learner:

a past date is selected using a calendar-based date time picker control to specify a DATE-type value, a review period is limited from the specified past date to a current date, and all applicable learning cards are extracted by performing an AND search using a learning-card creation date and the learning subject, under conditions that the creation date is equal to or later than the specified DATE-type value;

the learning cards are sortable based on difficulty levels of problem statements stored in the learning cards, and repeated practice using the stored learning cards is performed; and

15. The integrated learning system according to claim 13,

wherein, during review:

problem statements of learning cards that were not answered correctly are extracted, and repeated practice is performed using only the incorrectly answered problems;

elapsed time from a stored learning date to a review date and a savings rate are graphed to create a personal forgetting curve, and a personal forgetting curve is generated for each learning method to visualize an efficient learning method;

review is performed by clicking a “source text” button included in the learning card to activate an e-book viewer, display content corresponding to a directory stored in the learning card, and return to a source page used at a time of creation of the learning card to confirm described content; and

16. The integrated learning system according to claim 1,

wherein, during a learning-understanding stage and a review stage performed, by the learner, the learner’s operations are monitored, and points are awarded to each learner according to learning time, a number of created problems, a number of answered problems, and a number of searches, and accumulated points are exchangeable for benefits or prizes; and

wherein the learner pre-registers a learning start time, and when the learner starts studying within a predetermined number of minutes from the registered learning start time and continues studying for a predetermined duration, points are awarded to the learner.

1-56. (cancelled)

57. An integrated learning system comprising:
an e-book viewer configured to select a textbook, reference book, or learning book to be studied and to display content;
a content storage unit configured to store electronic documents;
a directory storage unit configured to store directory information of the content;
a learning subject storage unit configured to register and store learning subjects to be studied;
a target examination name storage unit configured to register and store a name of an examination to be taken;
a selected character string storage unit configured to select and store character strings in a document, the character strings including learning item names, words, technical terms, case numbers, and past examination question numbers;
a selected image character string conversion unit configured to select character images within an image in the document, convert the selected character images into editable text data, and store the converted text data as selected character strings in the selected character string storage unit;
a search engine configured to perform an Internet search using, as one set, the registered learning subject, the target examination name, and at least one of the selected character strings or the selected image character strings;
a network connected to the search engine;
a generative Al accessible via the network and configured to perform the search;
a search result display unit configured to display search results in a web browser;
a search result storage unit configured to store the learning subject, the selected character strings, and the search results;
a URL storage unit configured to store URLs accessed by the web browser;
a learning card display unit configured to display a learning card including a question section, an answer section, and a remarks section;
a learning display unit configured to display a learning screen including a learning-subject section and having a search function and a review function;
a learning result storage unit configured to store results learned in the learning screen as learning cards;
a date acquisition and storage unit configured to acquire and store a date on which learning is performed in the learning screen; and
a prompt automatic creation unit configured to automatically create prompts.

58. The integrated learning system according to claim 57,
wherein the e-book viewer is configured, when a file is selected and opened from a list of e- book files, to automatically acquire a learning subject described in the e-book file and store the acquired learning subject in the learning subject storage unit.

59. The integrated learning system according to claim 57,
wherein the e-book viewer is configured to:
acquire, when an e-book file is opened or when pages are turned, a directory in a PC in which the electronic content is stored and a page number of the e-book text from a displayed text page, and update and store the acquired directory and page number in the directory storage unit; and
store, when a character string on the text page is stored in the question section of a learning card and text from a website opened by a network search is stored in the answer section to create the learning card, the directory and page number stored in the directory storage unit in the learning card.

60. The integrated learning system according to claim 57,
wherein the e-book viewer is configured to, when a character string is selected from a displayed e-book text page and an Internet search is performed to open a website, acquire a URL of the opened website and store the acquired URL in the URL storage unit; and
store, when a character string from the text page is stored in a question section of a learning card and a character string from the website is stored in an answer section to create the learning card, the URL stored in the URL storage unit in the learning card.

61. The integrated learning system according to claim 57,
wherein the e-book viewer is configured, when learning is performed using text, figures, images, or explanatory videos displayed in the content display unit or a browser, to create question items representing unclear points in text or voice format, transmit the question items together with the learning subject to the generative AI and store question text and response text returned from the generative AI in the learning card.

62. The integrated learning system according to claim 57,
wherein the prompt automatic creation unit is configured to:
register, in advance, individual information of a learner indicating personal attributes including age and proficiency level;
select an appropriate template sentence from among a plurality of example sentences based on the registered information, apply the registered information to the selected template sentence, and automatically create a prompt under constraint conditions;
transmit, when the learner inputs and displays a question sentence on an e-book viewer screen and clicks a "question" button, the prompt together with the question sentence to the generative AI;
allow the learner to designate a personal tutor character defined in the system as an answering entity;
store, for each of a plurality of personal tutor characters, basic information including expertise, personality, and an expected answering standpoint, and corresponding character images;
allow the learner to designate a personal tutor character by clicking a corresponding character image; and
automatically select an appropriate template sentence and generate a prompt according to the designated personal tutor character, and transmit the generated prompt together with the question sentence to the generative AI when the learner clicks the "question" button.

63. The integrated learning system according to claim 57 wherein:
a problem statement related to the selected character string is generated by the generative AI;
the learner creates an answer to the problem statement;
the generative AI determines whether the answer is correct;
the learner repeatedly creates answers until the answer is determined to be correct;
after the answer is determined to be correct, the generative AI evaluates the learner's level of understanding and weaknesses based on exchanges of correct and incorrect answers with the learner, and generates and presents a next problem;
the problems, answers, and determinations generated by the generative AI are stored in the learning card;
part or all of a response returned from the generative AI is transmitted, together with a prompt requesting determination of truthfulness or factual accuracy, to a generative AI of a different system or company to determine reliability and confidence level and to identify problematic portions, and determination results including the confidence level and problematic portions are displayed in a browser;
the learner examines the response returned from the other generative AI by performing network searches based on the determination results, revises and corrects the response, retransmits the corrected response to the other generative AI and receives a further determination of confidence level and problematic portions; and
the learner repeats the operations until a target confidence level is reached and stores a response having an increased confidence level in the learning card.

64. The integrated learning system according to claim 63,
wherein creation of an answer is performed by any of:
keyboard input;
handwritten input digitized by a scanner;
handwriting on a touch panel; and
voice input;
wherein the learner creates and inputs a problem statement based on content understood by the learner;
wherein the learner submits the self-created problem statement to the generative AI and evaluates the learner's own level of understanding by comparing an assumed answer with a response returned from the generative AI; and
wherein the response returned from the generative AI is stored in the learning card as an answer to the learner's question.

65. The integrated learning system according to claim 57,
wherein the target examination name, the learning subject, and the selected character string are transmitted to the generative AI which searches for related past examination questions and lists a plurality of applicable past examination questions; and
wherein the learner selects and displays one of the listed past examination questions and stores a problem statement in the question section of the learning card, an answer statement in the answer section, and an explanation statement in the remarks section.

66. The integrated learning system according to claim 57,
wherein, during a learning-understanding stage, the learner performs text reading, network searches, viewing of explanatory videos, questioning the generative AI creation of similar problems, and searching for past examination questions, and stores understood content in the form of learning cards; and
wherein, when content understood by various methods is stored as learning cards, content of a question section of a created learning card, the target examination name, and the learning subject are transmitted to the generative AI to cause the generative AI to determine a difficulty level of the problem and a probability of appearance in the target examination, and determination results returned from the generative AI are stored in the learning card together with a creation date.

67. The integrated learning system according to claim 57,
wherein, when the learner finishes a learning-understanding stage:
the learner's operations during the learning process are transmitted to the generative AIto receive feedback and advice on learning methods;
a learning subject and learning items belonging to the learning subject are selected, and a pre- learning organization procedure is executed to create a pre-learning organization table,
the pre-learning organization procedure being configured to specify the learning items and, using the Internet or the generative AI generate an overview of the learning items, key points, advice and cautions regarding learning methods, a list of related web pages with links, and a learning method based on a standard learning time; and
the pre-learning organization table includes a learning-method column in which the learning items, the learning methods, and a standard estimated acquisition time based on the learning methods are stored.

68. The integrated learning system according to claim 57,
wherein, during a review stage performed by the learner:
review is performed by displaying a question section stored in a learning card and allowing the learner to estimate an answer, speak the answer aloud, or handwrite the answer;
a created answer is verified by displaying an answer section stored in the learning card and checking whether the stored answer matches the learner-created answer, and, if not matched, correcting the learner's memory or answering method in accordance with a sensory-motor learning method;
review is performed by allowing the learner to answer a problem statement stored in the learning card by voice;
review is performed while sequentially displaying the question section, the answer section, and a remarks section of the learning card;
display of the question section, the answer section, and the remarks section is performed by button clicks;
the learner selects an arbitrary time interval to automatically and sequentially display each of the question section, the answer section, and the remarks section of the learning card, and sequential display of corresponding sections of a next learning card is automatically continued;
and an opening and closing order of the question section, the answer section, and the remarks section is configurable for each learning card.

69. The integrated learning system according to claim 57,
wherein, during review:
learning cards to be reviewed are extracted based on elapsed time from a creation date of each learning card;
the learning cards to be reviewed are extracted according to review timings set based on an Ebbinghaus forgetting curve;
immediately after learning, when a savings rate most rapidly decreases on the Ebbinghaus forgetting curve, learning cards created immediately after learning are extracted by performing an AND search using the learning subject and a current date, and the extracted learning cards are continuously displayed for review;
learning cards to be reviewed are specified by selecting, from option buttons, card groups created on a creation date, one day after the creation date, three days after the creation date, one week after the creation date, or two weeks after the creation date, or by inputting a date using a calendar-based date time-picker control, and a specific learning card group is extracted based on the specified date; and
review is performed by repeatedly returning to a first question and continuously displaying the extracted group of learning cards.

70. The integrated learning system according to claim 69,
wherein, during a review stage performed by the learner:
a past date is selected using a calendar-based date time picker control to specify a DATE-type value, a review period is limited from the specified past date to a current date, and all applicable learning cards are extracted by performing an AND search using a learning-card creation date and the learning subject, under conditions that the creation date is equal to or later than the specified DATE-type value;
the learning cards are sortable based on difficulty levels of problem statements stored in the learning cards, and repeated practice using the stored learning cards is performed; and
the learning cards are sortable in descending order of occurrence probabilities of problem statements stored in the learning cards, and repeated practice using the sorted learning cards is performed.

71. The integrated learning system according to claim 69,
wherein, during review:
problem statements of learning cards that were not answered correctly are extracted, and repeated practice is performed using only the incorrectly answered problems;
elapsed time from a stored learning date to a review date and a savings rate are graphed to create a personal forgetting curve, and a personal forgetting curve is generated for each learning method to visualize an efficient learning method;
review is performed by clicking a "source text" button included in the learning card to activate an e-book viewer, display content corresponding to a directory stored in the learning card, and return to a source page used at a time of creation of the learning card to confirm described content; and
review is performed by clicking a "source site" button included in the learning card to activate an Internet browser, display a site corresponding to a URL stored in the learning card, and return to a source site used at the time of creation of the learning card to confirm described content.

72. The integrated learning system according to claim 57,
wherein, during a learning-understanding stage and a review stage performed, by the learner, the learner's operations are monitored, and points are awarded to each learner according to learning time, a number of created problems, a number of answered problems, and a number of searches, and accumulated points are exchangeable for benefits or prizes; and
wherein the learner pre-registers a learning start time, and when the learner starts studying within a predetermined number of minutes from the registered learning start time and continues studying for a predetermined duration, points are awarded to the learner.
